(19) United States
(12) Patent Application Publication
(10) Pub. No.: US 2015/0321391 A1
(43) Pub. Date: Nov. 12, 2015

(54) TRAILERIZED MOBILE EARTH BLOCK RAM WORKSTATION

(71) Applicant: John V. Rivera, Vero Beach, FL (US)

(72) Inventor: John V. Rivera, Vero Beach, FL (US)

(21) Appl. No.: 14/271,396

(22) Filed: May 6, 2014

(51) Int. Cl. B29C 43/02

(52) U.S. Cl. CPC B29C 43/02; B29L 2031/102

(57) ABSTRACT

The invention relates to the field of compressed earth block ramming machines for forming blocks for construction and other purposes, and more particularly to compressed earth block ramming machines that can be manually operated and hydraulically or pneumatically powered. More specifically, the present invention relates to a mobile trailerized workstation comprising one or more Compressed Earth Block (“CEB”) ram machines, which may be in a horizontal or other configuration. The invention is suitable for use in remote environments in support of, for instance, on-site construction operations utilizing earth blocks. The trailerized workstation may also comprise an electric generator, a mixer for mixing the earth block soil mixture, and a block compression testing apparatus. A preferred embodiment comprises two horizontal hydraulic earth block ram machines, a covered trailer, and a hydraulic pump and fluid lines for operating the horizontal rams.

This is document is a non-provisional application for patent filed in the United States Patent and Trademark Office (USPTO) under 35 U.S.C. §111(a).

### CROSS REFERENCE TO RELATED APPLICATIONS

Not applicable.

### STATEMENT REGARDING FEDERALLY SPONSORED RESEARCH OR DEVELOPMENT

Not applicable.

INCORPORATION-BY-REFERENCE OF MATERIAL SUBMITTED ON A COMPACT DISK

Not applicable.

### BACKGROUND OF THE INVENTION

1. Field of the Invention

This invention relates to compressed earth block ramming machines, and more particularly to compressed earth block ramming machines that can be manually operated and hydraulically or pneumatically powered and may be trailerized forming a mobile earth block ram system. More specifically, the present invention relates to a mobile trailerized system, which provides a workstation comprising one or more Compressed Earth Block (“CEB”) ram machines, which may be in a horizontal or other configuration, and method for producing earth blocks using same. The invention is suitable for use in remote environments without electricity or other external power, and be may be utilized in support of, for instance, on-site construction operations utilizing earth blocks. Such on-site construction may be useful in areas that do not have electric power, road infrastructure, or nearby sources of supply of building materials such as concrete block such as impoverished area or areas that have experienced recent natural disasters such as hurricanes, tornadoes, floods, earthquakes war or other conditions that case interruption in power or ability to transport building materials overland.

2. Background Art

It is estimated that about two billion people around the world rely on earthen construction for their shelters. Many of these shelters have been constructed from traditional sun dried adobe, rammed earth, and compressed soil blocks. Some of these structures have provided continuous shelter over the last 200 years with minimal maintenance. In many instances, it is desired to construct Earth block structures for uses such as, for example and not by way of limitation, dwellings, sheds, warehouses and other structures in remote locations which may not be located near electrical power or other services, and which may not be reachable except by rudimentary roads such as dirt or unpaved roads. In other instances, it may be desired to construct Earth block structures directly following a natural disaster such as a hurricane or flood. In such situations the availability of good roadways and services such as electrical service may be hindered due to the natural disaster. There are any number of other situations in which it is desired to construct a structure in locations and/or at a time or place in which the availability of electrical service or other services, or the availability of roads, is limited due to some circumstance. In these situations, it would be desirable to have a portable, durable, self-contained earth block fabrication station able to fabricate earth blocks on site and at a rapid enough production rate to support rapid erection of structures. It is also desirable that such structures be able to withstand environmental conditions so that they are usable for shelters, warehouses, schools, livestock shelters, bodegas, or other such structures. In many situations such as those described herein it is not possible to deliver construction materials such as cement blocks via traditional methods due to the distance from the source of the goods, the condition of the roadways, or combination of these and other factors. The advantage of earth blocks is that they may be constructed on site from locally available materials; however a need exists in the art for a durable, mobile, readily transportable, high production rate earth block production apparatus.

U.S. Pat. No. 5,919,497 to Kofahl (“the '497 patent”) describes an apparatus for forming building blocks includes an upright compression chamber with an upper end that serves both as an inlet and an outlet. In operation, a soil/cement mixture is loaded into the upper end of the compression chamber, a sliding gate is slid shut, and a ram□ compresses the mixture against the gate. The gate is opened while the ram is still under pressure, which allows the block to be ejected through the common inlet/outlet. Because the ram shown in the Kofahl patent has an upright orientation, an earth-feeding hopper cannot easily be attached and□ production is slow because the input of the mixture and the output of the blocks is at shoulder level, which makes handling heavy blocks difficult. Furthermore, the headgate of the machine does not compensate for wear and becomes loose in operation.

Another example of a compressed soil block machine is the Impact 2001, which is manufactured by Advanced Earthen Construction Technologies, Inc., of San Antonio, Tex. The Impact 2001 is a hydraulic machine that rams blocks along a vertical axis and then pushes them out on a horizontal axis. In this case, an earth-feed hopper can be moved over the retracted vertical ramming chamber while simultaneously pushing the previously rammed block out, filling the ramming chamber with a fresh charge, and sealing the chamber for the next cycle. Although the Impact 2001 may be an ergonomic improvement over the machine shown by the '497 patent, it is unnecessarily complex (and thus difficult to repair) and expensive, especially in remote country use. Moreover, the vertical dimension of the blocks formed using the Impact 2001 varies too much for use in the interlock dry-stack system; these blocks are meant for lay-up in mortar.

The Green Machine is another known ramming machine (sold by the Green Machine Technology Company, of Middleburg, Va.) and shares many of the mechanical design features of the Impact 2001. This machine, however, is more mechanically complex, more automated, employs a stop feature in the vertical ramming action which is claimed to result in a consistent vertical dimension of the blocks produced therewith. Like the Impact 2001, the Green 55 ramming machine is expensive, complicated to repair, expensive to ship, and uses a number of mechanical parts that are not readily available.

Another block ramming machine is the CinvaRam (which was manufactured by Metalibec Ltda., of Bogota, Columbia and sold by Schrader Bellows, of Akron, Ohio). The CinvaRam was developed in the 1950's as a simple, vertical axis ramming machine that uses a hand lever to provide a mechanical advantage for providing increased ramming pressures. The CinvaRam has no hopper; earth is filled into an open top of the ramming chamber when the ramming plate is retracted downward. During operation, the cover is then rotated into place and the level arm is brought across the top and the ramming plate is raised against the top. In addition to being slow, the CinvaRam machine produces blocks with a relatively low density (i.e., poor hardness after cure), which may not satisfy building codes.

Elkins U.S. Pat. No. 4,579,706 (“the '706 patent”) describes an apparatus for making blocks from earth, soil, or like material. The '706 patent has a horizontally disposed channel that is provided with (a) a fill chamber, (b) a compression chamber downstream of the fill chamber, and (c) means that, during a first cycle and while inhibiting further material from being supplied to the fill chamber, moves already supplied material from the fill chamber to the compression chamber to form a block and that, during a second cycle, enables further material to be supplied to the fill chamber. A disadvantage of the apparatus shown in the '706 patent is that the end wall of the ramming chamber moves in a direction that is perpendicular to the channel, making it difficult, for example, to form certain types of tongue and groove styled block ends. Moreover, the apparatus shown in the '706 patent necessarily uses different actuators to form blocks and to move blocks after they are formed, which increases the complexity and cost of the machine and reduces reliability.

Another earth block ram machine is described in U.S. Pat. No. 6,347,931 to Underwood, which is incorporated herein in its entirety by reference. This U.S. patent describes a block ramming machine that includes: (a) a ramming chamber structure having a longitudinal axis, an input end, an output end, and a ramming chamber located between the input and output ends, (b) a headgate assembly located near the output end of the ramming chamber, wherein the assembly comprises a headgate that can have at least an open position and a closed position, (c) a fill chamber structure positioned along the longitudinal axis and having a first end, a second end, and a fill chamber located between the first and second ends, the input end and the second end being coupled so that the material can be transferred from the fill chamber to the ramming chamber, (d) a ramming plate for pushing the material from the fill chamber to the ramming chamber, and (e) an actuator for moving the ramming plate along the longitudinal axis from a position in the fill chamber to a position in the ramming chamber, thereby transferring the material from the fill chamber to the ramming chamber to form a block.

However, none of the aforementioned earth block ram machines allow for interchangeable ram components such as ram heads and chambers, allowing for the use of different ram heads and chambers for pressing earth blocks and resulting in the production of any shape of earth block desired. Different earth block shapes may include channels for interlocking blocks, channels that create passageways when the blocks are stacked so that electrical cables, plumbing and the like may pass along, within or thru walls constructed by stacking earth blocks and the like or mobile, trailerized units comprising multiple earth block machines, along with air compressors and electrical generation equipment, forming a single trailered unit that is capable of producing earth blocks at a rapid rate and is also capable of providing compressed air and electrical power to the construction site, and especially remote construction sites. Because the typical construction site that may make use of earth blocks may be locations in which it is difficult or impossible to deliver traditional building materials such as those building sites located in a remote location, or located in a disaster zone, an invention satisfying the above shortcomings is needed.

### BRIEF SUMMARY OF THE INVENTION

The present invention comprises a system, apparatus and method that have one or more of the following features and/or steps, which alone or in any combination may comprise patentable subject matter. The best mode of the invention as currently conceived is described herein as the preferred embodiments of the invention.

In a preferred embodiment, the trailerized mobile earth block ram system and workstation of the invention comprises a trailer, at least one but preferably two earth block ram apparatuses for producing compressed earth blocks, at least one energy source such as, for example, and a hydraulic pump or pneumatic pump. The invention may further comprise a plurality of earth block ram apparatuses, a cement mixer, an electric generator which may be, for example, gas powered, propane powered, or powered by other sources to produce electricity, and an air compressor. A preferred embodiment may also comprise a compression testing apparatus for compression testing earth blocks and may also comprise an earth block slicing apparatus for slicing earth blocks to create a 45° or other angled end face which may usable for creating corners in structures created from stacked earth blocks, and the for slicing the protruding tongue of earth blocks so as to create earth blocks with a flat upper surface devoid of the tongue. The trailer of the invention may be adapted to be towed by a tow vehicle such as a pickup, tractor, snowmobile or any other motorized vehicle and may include a receiver for a ball hitch as is known in the art, or any other mechanical structure for allowing towing by a tow vehicle or animal The trailer of the invention may be an open trailer without covers or maybe an enclosed trailer comprising a top cover, side covers, front cover and a rear cover that may operate to completely enclose the earth block ram machines and other components of the invention with a lockable closure such that theft of the earth block ram machines, cement mixer, electric generator, compression testing apparatus, slicing apparatus, assorted tools and raw materials that are stored within the trailer enclosure may be prevented. The trailer of the invention may be a single axle or multiple axle configuration. The earth block ram apparatus or apparatuses of the invention may further comprise a fill chamber, a ram chamber, a head gate apparatus for forming one end of the ram chamber, a ram apparatus including a ram head for forming a second end of the ram chamber, a shelf or shelves upon which earth blocks may be motivated after being formed in the ram chamber, and means for controlling the head gate apparatus and ram apparatus. In a preferred embodiment, the head gate apparatus and ram apparatus comprise hydraulic cylinders, the energy source may comprise a hydraulic pump connected to a hydraulic fluid reservoir, wherein the hydraulic pump may be further defined as gasoline powered, and wherein each hydraulic pump further comprises a control mechanism by which an operator can extend and retract the hydraulic cylinders as is known in the art. The hydraulic cylinders may be, but are not necessarily, double acting such that they may be commanded to extend and hold the extended position, and likewise may be commanded to retract and hold the retracted position, as desired by the operator.

In a preferred embodiment and best mode of the invention, the mobile earth block ram system and workstation of the invention comprises two earth block ram apparatuses for forming earth blocks, so that two independent earth block fabrication procedures may be in process at any given time, each independent earth block fabrication procedure producing earth blocks and being independently controlled by the operator or operators. In this application, “operator” and “user” are synonymous. Further, in the best mode of the invention, the energy sources are hydraulic, the cylinders of the invention are hydraulic, the trailer is of a single axis configuration and comprises a top cover, to side covers, a rear cover in the front cover, and all covers are lockable when closed and may be held in an open position by pneumatic or hydraulic cylinders.

Thus it may be seen that the preferred embodiment of the trailerized mobile earth block ram workstation of the invention is adapted to be towed by a tow vehicle to a work site, such as a remote site or a site in a disaster zone where it may be utilized to create earth blocks suitable for construction of structures using naturally available resources such as dirt, mixed with cement or other materials. The trailerized mobile earth block ram workstation of the invention therefore enables rapid construction of shelters and the like with minimal outside resources on a rapid deployment basis and does not require electricity to operate.

### BRIEF DESCRIPTION OF THE DRAWINGS

The accompanying drawings, which are incorporated into and form a part of the specification, illustrate one or more embodiments of the present invention and, together with the description, serve to explain the principles of the invention. The drawings are only for the purpose of illustrating the preferred embodiments of the invention and are not to be construed as limiting the invention. In the drawings:

FIG. 1 depicts a side view of a preferred embodiment of the mobile earth block ram workstation apparatus of the invention hitched to a tow vehicle and in use at a construction site.

FIG. 2a depicts a perspective front view of a preferred embodiment of the mobile earth block ram workstation apparatus of the invention with the trailer side covers, front cover, and rear cover in an open position.

FIG. 2b depicts a perspective rear view of a preferred embodiment of the mobile earth block ram workstation apparatus of the invention with the trailer side covers, front cover, and rear cover in an open position.

FIG. 2c depicts a perspective front view of a preferred embodiment of the mobile earth block ram workstation apparatus of the invention with the trailer side covers, front cover, and rear cover in a closed position.

FIG. 3 depicts a first top perspective view of a preferred embodiment of the ram apparatus of the invention.

FIG. 4a depicts a second top view of a preferred embodiment of the ram apparatus of the invention.

FIG. 4b depicts a cross section view of a preferred embodiment of the ram apparatus of the invention showing detail of the ram compression chamber.

FIG. 5a depicts a side cross-section view of a preferred embodiment of the ram apparatus of the invention during an initial stage of the earth block ram procedure in which the Earth cement mixture has been loaded into the fill chamber of the invention.

FIG. 5b depicts a side cross-section view of a preferred embodiment of the ram apparatus of the invention during a second stage of the earth block ram procedure in which the Earth cement mixture is being compressed in the ramming chamber of the invention.

FIG. 5c depicts a side cross-section view of a preferred embodiment of the ram apparatus of the invention during a third stage of the earth block ram procedure in which an Earth block has been formed by the RAM procedure and has been moved to a block exit shelf of the invention.

FIG. 6a depicts a perspective view of one embodiment of the head gate apparatus of the invention, depicting the head gate sliding engagement in the head gate vertical supports.

FIG. 6b depicts a side view of an alternative embodiment of the head gate apparatus of the invention in which mandrels, which may take any shape, are utilized to form through channels in the earth block being formed in the ram chamber.

FIG. 7a depicts a first embodiment of a compressed earth block formed by the apparatus of the invention.

FIG. 7b depicts a second embodiment of compressed earth block formed by the apparatus of the invention.

FIG. 7c depicts a third embodiment of compressed earth block formed by the apparatus of the invention.

FIG. 7d depicts a fourth embodiment of compressed earth block formed by the apparatus of the invention.

FIG. 7e depicts a basic compressed earth block that may be produced by the invention, in which all six sides are featureless.

FIG. 7f depicts a stack of compressed earth blocks of a first embodiment produced by the invention.

FIG. 7g depicts a stack of compressed earth blocks of a second embodiment produced by the invention.

FIG. 7h depicts a stack of compressed earth blocks of a third embodiment produced by the invention.

FIG. 7i depicts a stack of compressed earth blocks of a fourth embodiment produced by the invention.

FIG. 7j depicts a corner block that may be produced by the invention by using the earth block slicing apparatus to slice the tongue from a compressed earth block.

FIG. 8 depicts a typical floor plan of a preferred embodiment of the mobile earth block ram workstation apparatus of the invention.

FIG. 9 depicts a table of typical compression values and compression times for forming compressed earth blocks using the invention.

FIG. 10 depicts a pressurized fluid block diagram of a preferred embodiment of the invention.

FIG. 11a depicts a front view of a compression testing device of the invention.

FIG. 11b depicts a right side view of a compression testing device of the invention.

FIG. 11c depicts a perspective view of a compression testing device of the invention.

FIG. 12a depicts a top view of an earth block slicing apparatus of the invention.

FIG. 12b depicts a side view of an earth block slicing apparatus of the invention.

FIG. 12c depicts a cross-section view of the earth block slicing apparatus of the invention being utilized to slice the tongue from an earth block.

FIG. 13 depicts a schematic diagram of the solar powered lighting of the invention.

### DETAILED DESCRIPTION OF THE INVENTION

The following documentation provides a detailed description of the invention.

As used herein, “earth block” and “compressed earth block”, or CEB, mean a block formed by compressing earth or earth mix in a chamber for a period of time to form a desired block shape. An earth block may be formed of earth alone or may be formed of earth in combination with other materials such as, for example, resins, cement, epoxy or any other desired material. The earth or earth mixed with other materials that is used to form an earth block is termed “earth mix”.

As used herein, “trailer” has the meaning known in the art and may comprise at, may comprise any number of wheels and axles, and may be adapted for towing by a tow vehicle or animal.

As used herein, “controllable cylinder” means a hydraulic, pneumatic or electric-solenoid powered cylinder that may be double-acting, meaning that it may be commanded to extend or may be commanded to retract along a longitudinal axis; or may be an electrically operated device such as a solenoid operated devices. Alternatively a controllable cylinder of the invention or may be single acting. A controllable cylinder may be commanded to extend or may be commanded to retract along a longitudinal axis. As used herein, the terms “controllable cylinder” and “cylinder” may be used interchangeably, which means that any reference to a “cylinder” is to be construed as a reference to a “controllable cylinder”.

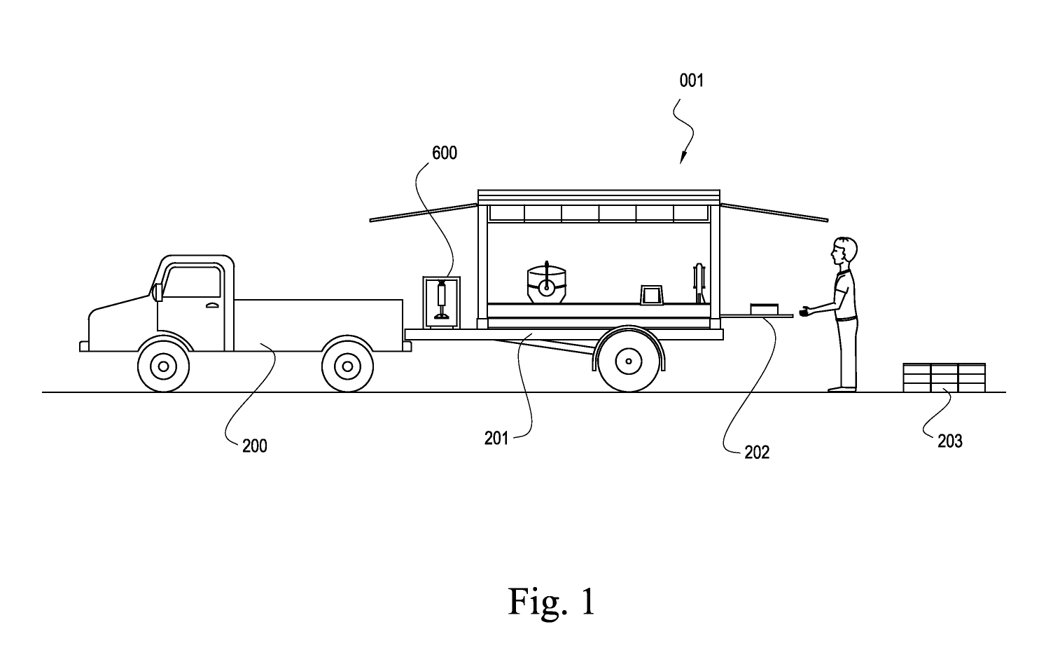

Referring now to FIG. 1, a side view of a preferred embodiment of the trailerized mobile earth block ram workstation apparatus of the invention 001 hitched to a tow vehicle and in use at a construction site is depicted in which the mobile earth block ram workstation apparatus is shown attached to a tow vehicle 200. The tow vehicle 200 may be any vehicle capable of towing a trailer such as, for example, a pickup truck, a tractor, a snowmobile, or any motorized vehicle. The trailerized mobile earth block ram workstation apparatus, which may comprise trailer 201, may also be adapted to be towed by beasts of burden such as horses, mules, oxen or other animals. The means for towing the trailerized mobile earth block ram workstation apparatus of the invention is not intended to be a limitation of the invention.

As can be seen in FIG. 1 in a preferred embodiment of the invention the invention may comprise side covers, front cover and rear cover that are hingedly connected to a frame of the trailer of the invention and may further be defined as being hinged at the top, allowing the covers to be opened by pulling them from the bottom and swinging them away from the trailer and upward into an open position where they may be retained in the open position by use of hydraulic or pneumatic cylinders as is known in the art. The covers may be retained in the open position by any mechanical means as may be known in the art. Each cover may also comprise a hasp for locking the cover into a closed position; preferably each cover lock hasp may be located at or near the lower edge of the cover and may be adapted to accept the shank of a lock. Each hasp may be utilized with a lock such as a combination or key lock as is known in the art and may engage a matching hasp mechanism located on the trailer such that each of the side covers, front cover and rear cover may be locked in a closed position enabling the trailerized mobile earth block ram workstation apparatus of the invention to be locked on all four sides. The ability to lock all four sides into place in a closed position may be important as it may be desired to use the trailerized mobile earth block ram workstation apparatus of the invention in areas in which security is at a minimum for any number of reasons. For instance, in a preferred embodiment, the trailerized mobile earth block ram workstation apparatus of the invention may further comprise a cement mixer, cans of gasoline, an air compressor, tools for repair and maintenance, engine oil, hydraulic oil, bags of cement for mixing with local earth for fabricating earth blocks, and other tools, materials and/or equipment. These components may be safely stored in the closed and locked trailerized mobile earth block ram workstation apparatus of the invention, thus allowing the operators to secure the invention and its associated tools and materials should they need to leave the job site for any reason.

Still referring to FIG. 1, it can be seen that as Earth blocks are formed by the invention, they may be motivated onto shelf 202 where they may be picked up by an operator and utilized to form a structure 203. Shelf 202 may constructed of any structural sufficient to support a compressed earth block such as, for example, metal, formed sheet metal, plastic, fiberglass, wood or any other structural material. In constructing an earth block structure, mortar may be used between the blocks to secure them into place, or, alternatively, features such as channels in the blocks may be utilized to securely hold the blocks in place without the use of mortar to form a structure. It is an aspect of the invention that the invention may comprise an interchangeable ram chamber, head gate and ram head in order to form various kinds of blocks comprising alternate embodiments for channels in any number of block configurations. Such alternate earth block embodiments may comprise tongue elements on the top of an earth block that interlock with matching groove elements on the bottom of a mating earth block. Such alternate earth block embodiments may also comprise horizontal and/or vertical voids, or spaces, that may align when earth blocks are stacked, forming horizontal and/or vertical voids or spaces within walls constructed of such earth blocks. Such horizontal and/or vertical voids, or spaces, may be utilized to run cabling, electric power, communications cables, plumbing or other infrastructure securely within the earth block wall.

Still referring to FIG. 1, the invention may further comprise a compression testing device 600 that may be utilized to apply compressive test forces to a compressed earth block, or other block, as may be desired by a user of the invention. If a compressed earth block shows visible signs of cracking or physical deformation at or below a predetermined pressure, the user may determine that the earth mix composition must be adjusted in order to build a structure of sufficient strength. Thus the compression testing device 600 may be utilized to test earth blocks produced by the invention on a sample basis during a production run to ensure that minimum strength requirements are met. Compression testing device 600 may be mounted anywhere on trailer 201 but is preferably mounted on the tongue of trailer 201 for ease of access, and to reduce clutter and increase available space in trailer 201. Compression testing device 600 may be mounted onto trailer 201 by any means known in the art, but is preferably attached by use of threaded fasteners in any of the manners known to utilize such fasteners.

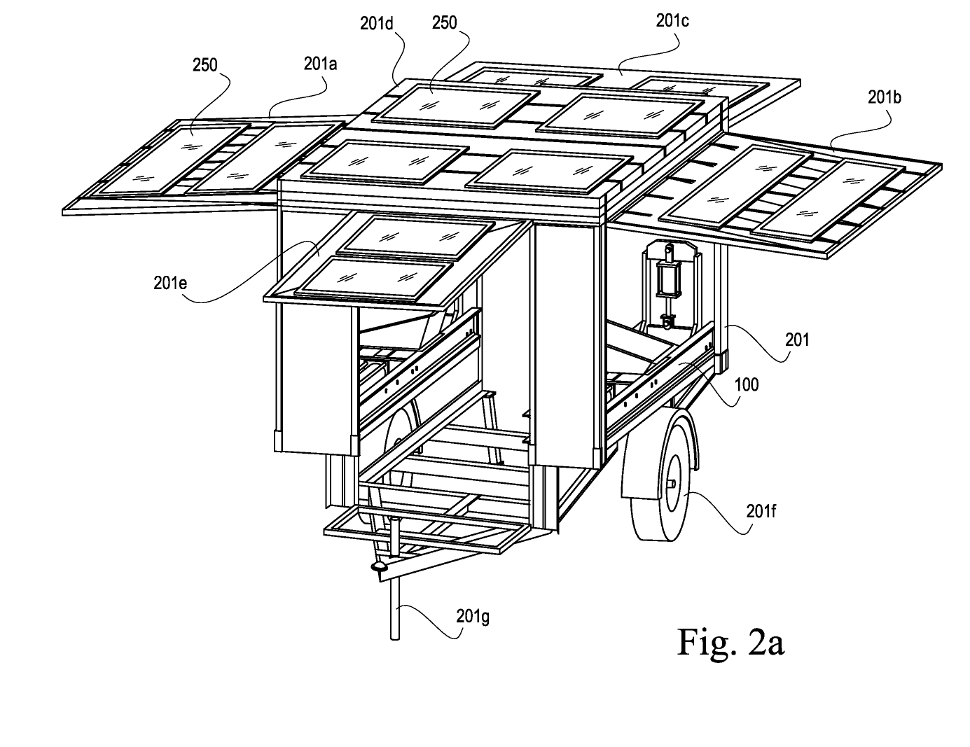

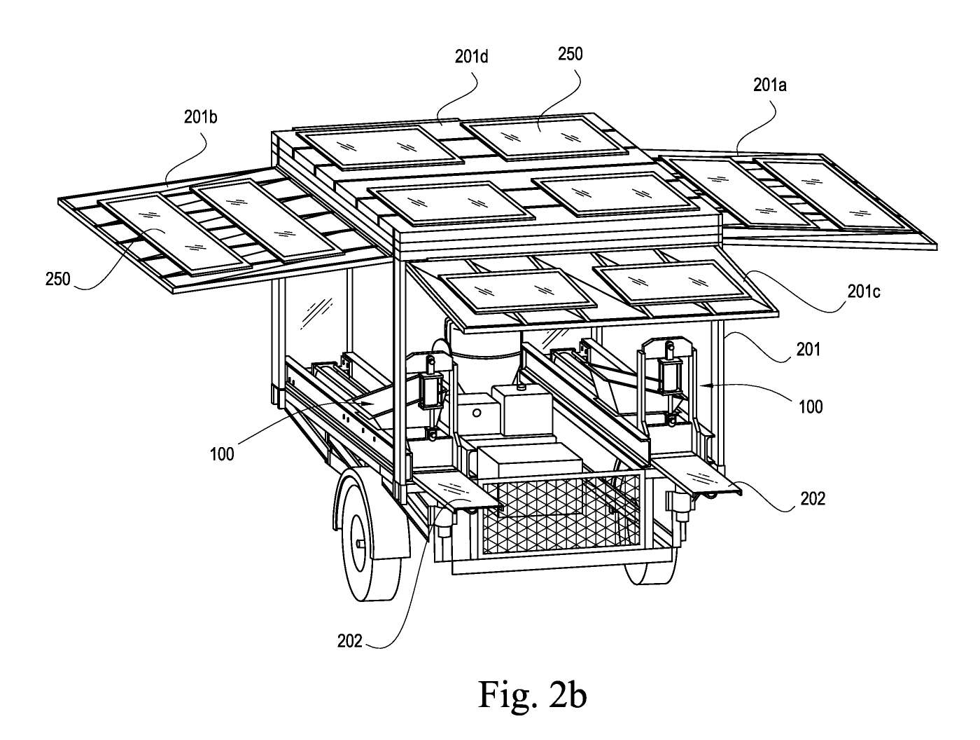

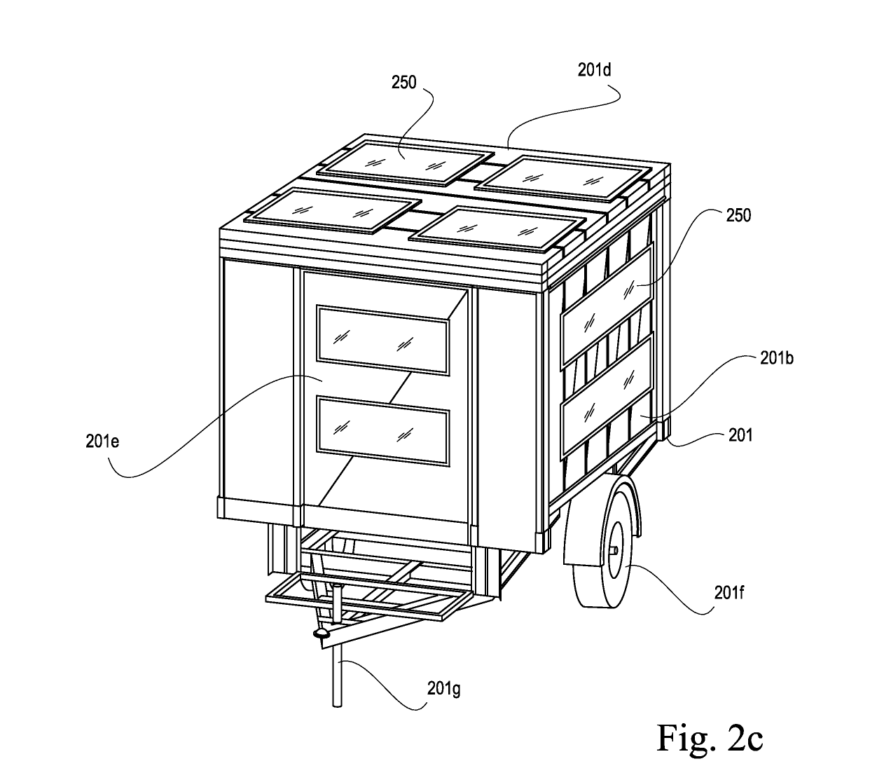

Referring now to FIG. 2a, a perspective front view of a preferred embodiment of the mobile earth block ram workstation apparatus of the invention with the trailer side covers, front cover, and rear cover in an open position is depicted. Trailer 201 may, but does not necessarily, comprise right side cover 201a, left side cover 201b, rear cover 201c, top cover 201d, front cover 201e, at least one wheel 201f, and a trailer tongue with leveling jack 201g. For ease of viewing, compression test device 600 is not shown in FIG. 2a but it is understood that it may be mounted on the tongue of trailer 201. It can easily be seen from FIG. 2a, which shows the trailer in an open configuration with all covers disposed in an open position, that the trailer may be utilized for Earth block making operations with one or more of the covers in an open position. The trailer may also comprise a floor, not depicted in FIG. 2a, upon which the various equipment of the invention may be mounted or placed as described further herein. The trailer may be adapted to be towed behind a tow vehicle, which may comprise any motorized vehicle or animal suitable for pulling the trailer. The invention may be transported to remote locations and may there be used for fabricating Earth blocks directly on the construction site. The invention may also be utilized in any location to fabricate Earth blocks for transport to a remote site, or may be located in virtually any location and used to fabricate Earth blocks as desired by the user.

Still referring to FIG. 2a, a preferred embodiment of the invention comprises two earth block ram apparatuses 100, each preferably but not necessarily mounted in substantially parallel orientation. While the depiction of the invention in the figures of the drawings depicts the two earth block ram apparatuses 100 disposed so as to be parallel with the line of travel of trailer 201, it is to be noted that such orientation is not necessary and that the two earth block ram apparatuses 100 may be disposed on the trailer in any orientation and at any angle to the direction of travel of trailer 201.

Still referring to FIG. 2a, a preferred embodiment of the invention comprises at least one, but preferably a plurality, of solar panels 250 attached to one or more covers of trailer 201 such that, when the covers are opened and retained in an open position, said solar panels are oriented such that their solar collecting faces face generally sky-ward. Solar panels 250 may be attached to any combination of covers 201a, 201b, 201c, 201d, or 201e by any means known in the mechanical arts but are preferably removably attached using threaded fasteners. Solar panels 250 may be in electrical communication with a solar panel power converter that operates to charge a battery. The battery may be in electrical communication through an electrical switch with at least one, but preferably a plurality, of lights attached the underside of any combination of 201a, 201b, 201c, 201d, or 201e or any other structure of the invention by any means known in the mechanical arts but are preferably removably attached using threaded fasteners. Using the solar panels, power converter, battery, switch and lights allows a user to store energy from the sun to power lights for night time operation of the invention without the need for an external power source.

Referring now to FIG. 2b, a perspective rear view of a preferred embodiment of the mobile earth block ram workstation apparatus of the invention with the trailer side covers, front cover, and rear cover in an open position is depicted. Trailer 201 may, but does not necessarily, comprise right side cover 201a, left side cover 201b, rear cover 201c, top cover 201d, and front cover 201e (not shown). The invention may further comprise at least one ram apparatus 100. In the preferred embodiment and best mode of the invention depicted in FIG. 2b, the invention comprises two ram apparatuses 100. In the preferred embodiment in which each ram apparatus 100 is disposed lengthwise in parallel with the axis of the trailer, one ram apparatus 100 may be disposed on the left side of the trailer, and one ram apparatus 100 may be disposed on the right side of the trailer.

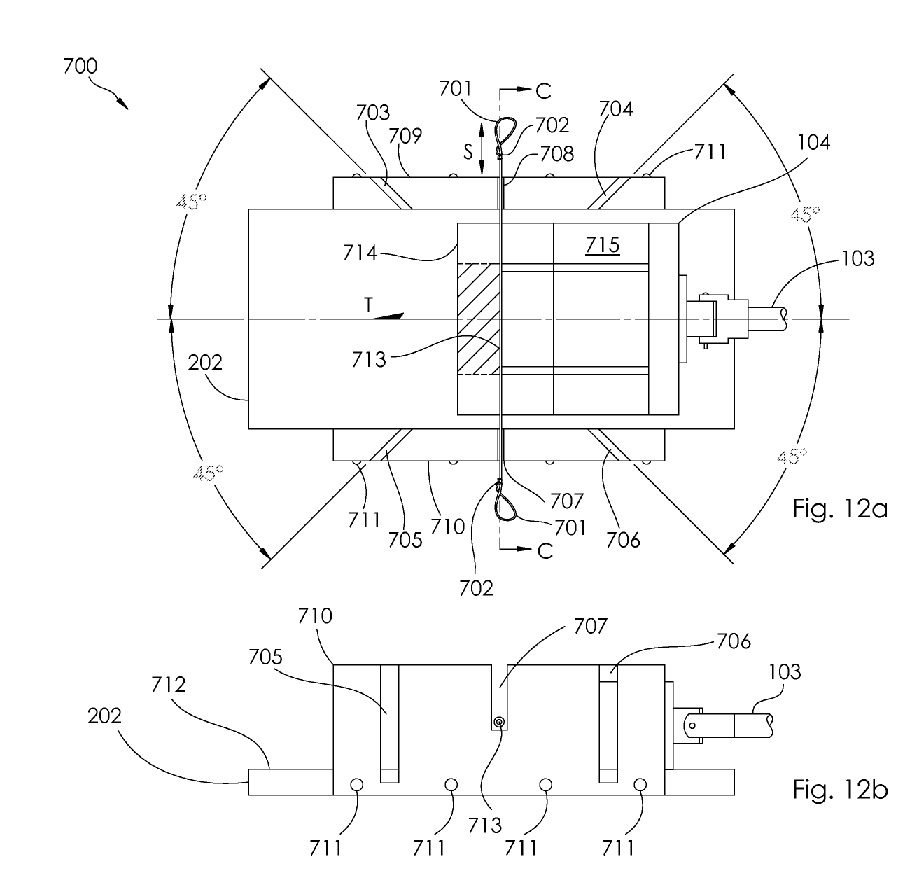

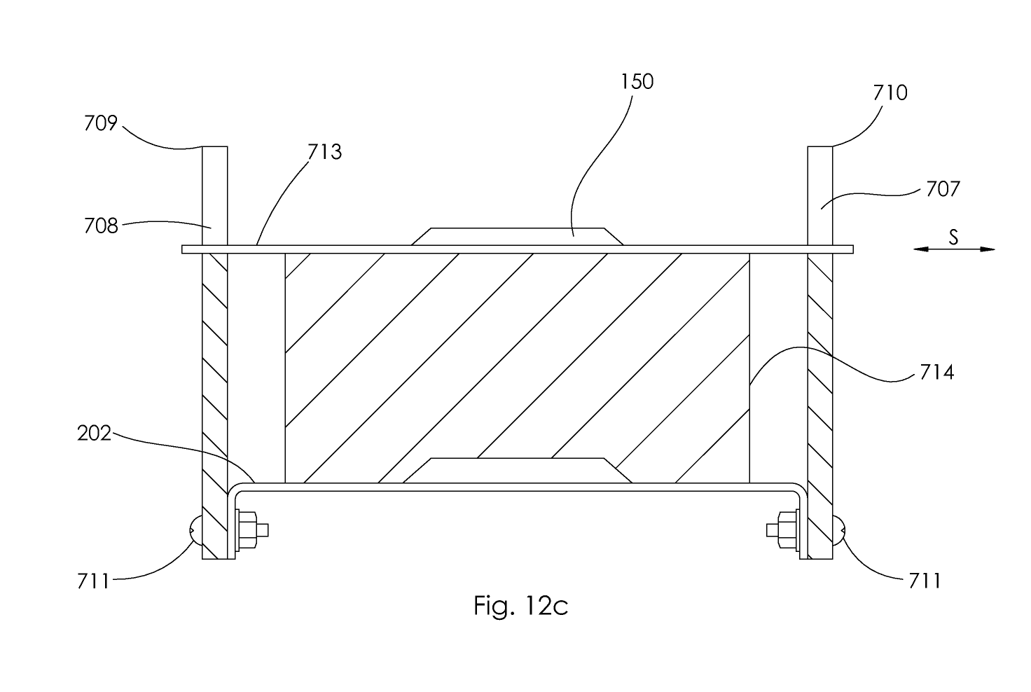

It can be seen from FIG. 2b that an earth mix may be fed into the hopper and thus the fill chamber of each ram apparatus 100 where it may then be compressed by the ram head of each ram apparatus as each ram head is motivated by its associated ram actuating device, compressing the earth mix into a compressed earth block in the ram chamber of each ram apparatus. Each completed compressed earth block may then be motivated onto shelf 202 by the associated ram cylinder and ram head of the relative ram apparatus, where each earth block may be then removed and placed in an appropriate location for curing and use in construction of a structure. The best mode and preferred embodiment depicted in FIG. 2b comprises two ram apparatuses which may be operated independently of one another and thus two earth blocks may be fabricated simultaneously by the embodiment of the invention depicted in FIG. 2b, dramatically increasing production throughput over existing Earth block systems. The invention may further comprise an earth block slicing apparatus 700 (not shown in FIG. 2b but shown in FIGS. 12a and 12b) that may be attached to a upper surface of either one or both of exit shelves 202.

Still referring to FIG. 2b, a preferred embodiment of the invention comprises at least one, but preferably a plurality, of solar panels 250 attached to one or more covers of trailer 201 such that, when the covers are opened and retained in an open position, said solar panels are oriented such that their solar collecting faces face generally sky-ward. Solar panels 250 may be attached to any combination of covers 201a, 201b, 201c, 201d, or 201e by any means known in the mechanical arts but are preferably removably attached using threaded fasteners. Solar panels 250 may be utilized to collect solar energy for storage in battery to provide electric power that may be used, for example, at night to power lights mounted on the underneath surfaces of any or all of covers 201a, 201b, 201c, 201d, or 201e as herein described.

Referring now to FIG. 2c, a perspective front view of a preferred embodiment of the mobile earth block ram workstation apparatus of the invention with the trailer side covers, front cover, and rear cover in a closed position is depicted. As can be seen in FIG. 2c, the covers of the invention have been lowered into a closed position where they may be locked by means of a hasp and matching keeper located on the cover and the frame of the trailer, where the covers of the invention may locked into place by a standard lock such as a combination lock, a key lock or any other kind of lock known in the art. Once all the covers of the invention are lowered into a closed position and locked, the resulting enclosure creates a secure environment for storing the various elements of the invention and the associated equipment as described herein. This security function of the invention may be important as the invention may be utilized in remote locations in which security is minimal. Still referring to FIG. 2c, left side cover 201b and front cover 201e are shown lowered into the closed position. The top cover 201d is shown for reference as is wheel 201f and trailer jack 201g. For ease of viewing, compression test device 600 is not shown in FIG. 2c but it is understood that it may be mounted on the tongue of trailer 201. Still referring to FIG. 2c, a preferred embodiment of the invention comprises at least one, but preferably a plurality, of solar panels 250 attached to one or more covers of trailer 201.

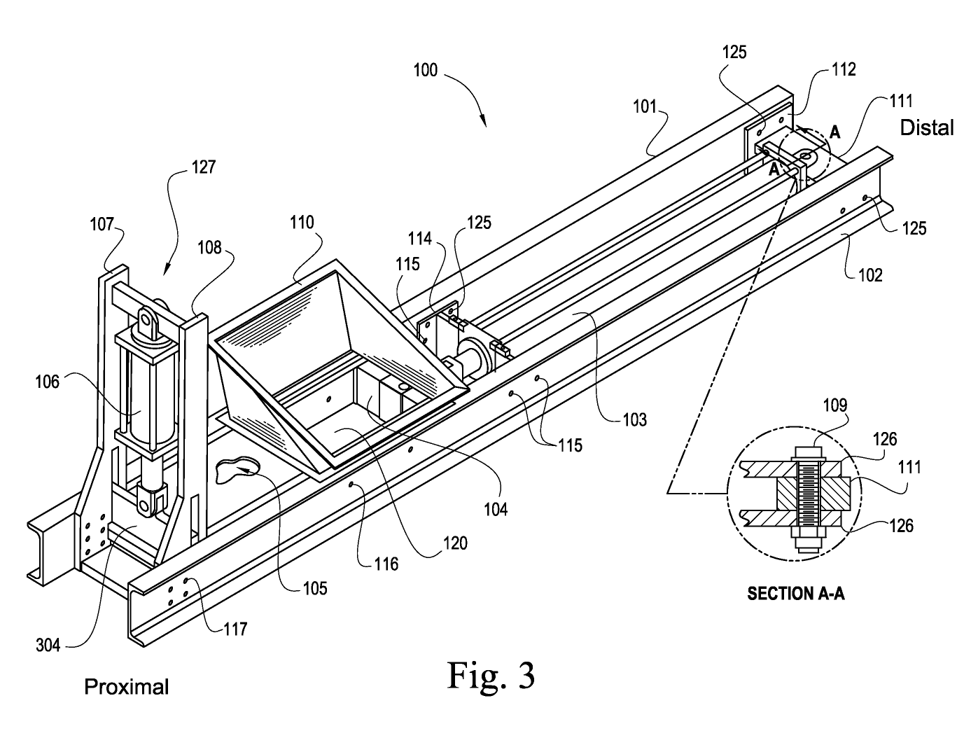

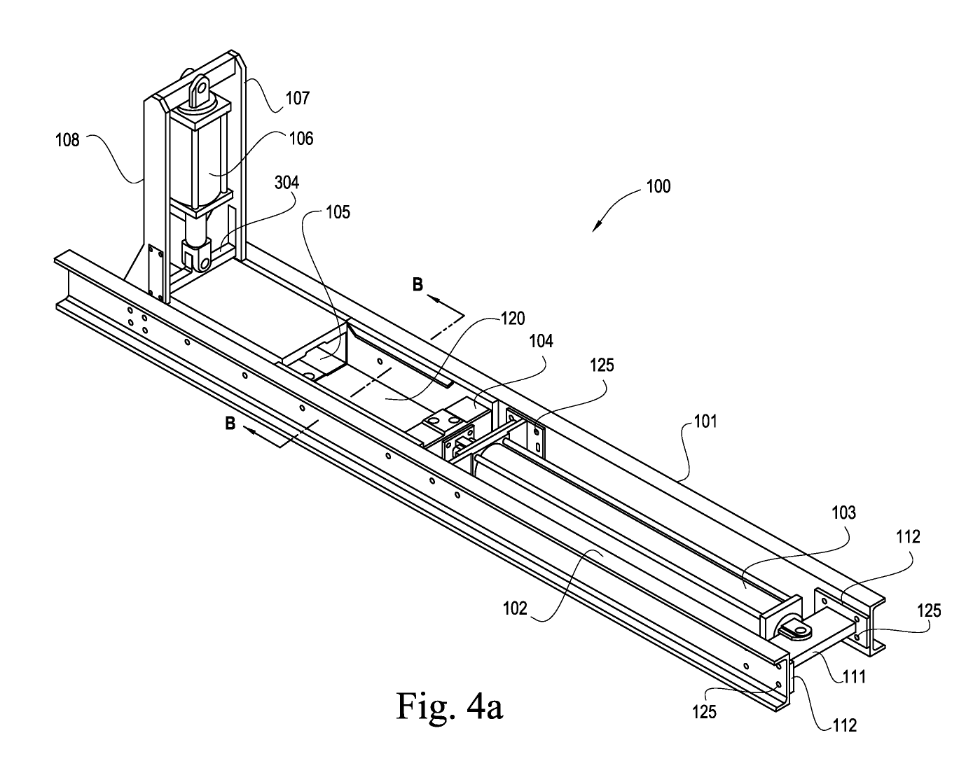

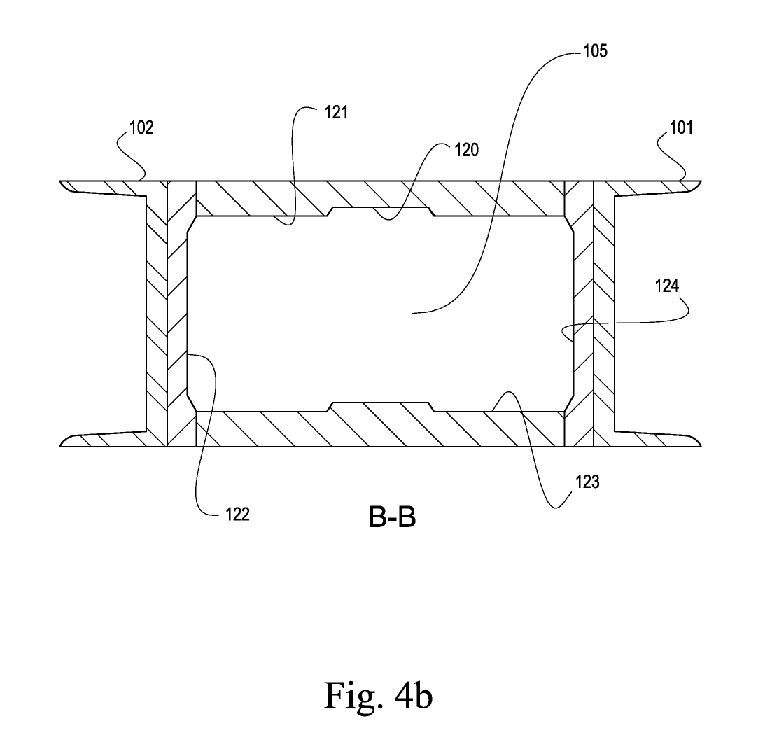

Referring now to FIGS. 3 and 4a, a first and second top perspective view of a preferred embodiment of the ram apparatus 100 of the invention is depicted. First ram side structure 101 and second ram side structure 102 may be disposed in a substantially parallel orientation along either side of ram apparatus 100. First horizontal cross member 111 may be attached to cross member mounting plates 112 disposed on either side of cross member 111 by any means known in the mechanical art such as, for example, welding, chemical bonding, or by forming from metal or other structural materials, including plastics, using known forming processes such as forging, casting, molding or the like, or any other method and material known in the art for forming structural components. In the preferred configuration depicted in the figures of the drawings, first horizontal ram cross member 111 and cross member mounting plates 112 may act to connect first ram side structure 101 and second ram side structure 102 together. Cross member mounting plates 112 are preferably bolted to first ram side structure 101 and second ram side structure 102 using mounting hardware 125 which may be, for example, bolts accepted by female threaded holes, to allow easy disassembly and re-assembly, but cross member mounting plates 112 may be attached to first ram side structure 101 and second ram side structure 102 by any means known in the mechanical arts including permanent attachment means such as for example, and not by way of limitation, welding, riveting or chemical bonding, or releasable attachment means such as threaded fasteners, joints such as dovetail joints, or any fastener or joint configuration that allows disassembly.

Still referring to FIGS. 3 and 4a, first ram side structure 102 and second ram side structure 102 may be of any cross-sectional shape but is preferably a C-channel cross-section as depicted in the figures of the drawings. It is to be noted, however, that although a C-channel cross section is the preferred embodiment depicted in the drawings, first ram side structure 102 and second ram side structure 102 may comprise any cross-sectional shape. Ram actuating device 103, which is preferably a controllable cylinder, may comprise flange 126 at its distal end and may be attached to first horizontal cross member 111 at its distal end by mounting hardware such as the hardware depicted as item 109 in section A-A of FIG. 3. Ram actuating device 103 may comprise a flange or flanges 113 which are accepted by first horizontal cross member 111 and may be bolted thereto by hardware 109 which may comprise, for example, threaded fasteners such as those depicted in section A-A of FIG. 3 passing through clearance holes in first horizontal cross member 111 and flange 126. This preferred configuration for mounting ram actuating device 103 at its distal end to first horizontal cross member 111 utilizes releasable attachment means and allows for quick assembly and disassembly of the invention. Note however that any means known in the mechanical arts may be used to attach distal end of ram actuating device 103 to first horizontal cross member 111, such as a pin retained by a cotter pin, and such attachment need not be releasable. Ram actuating device 103 may be attached at its proximal end to second horizontal cross member 113 which may be attached to first ram side structure 101 and second ram side structure 102 in similar fashion as first horizontal cross member 111 such as by cross member mounting plates 114. Cross member mounting plates 114 are preferably bolted to first ram side structure 101 and second ram side structure 102 to allow easy disassembly and re-assembly using mounting hardware 115 which may be, for example, threaded fasteners, but cross member mounting plates 114 may be attached to first ram side structure 101 and second ram side structure 102 by any means known in the mechanical arts including permanent attachment means such as for example, and not by way of limitation, welding, riveting or chemical bonding, or releasable attachment means such as threaded fasteners, joints such as dovetail joints, or any fastener or joint configuration that allows disassembly. The proximal end of ram actuating device 103 may comprise a mounting flange which further comprises holes for accepting mounting hardware such as, for example, threaded fasteners. Such mounting holes may be any configuration but may preferably be female threaded holes for accepting male threaded fasteners with matching threads. Thus, in a preferred embodiment of the invention, the proximal end of ram actuating device 103 may be attached to second horizontal cross member 113 by any means known in the mechanical arts, but preferably by threaded male fasteners passing through clearance holes in second horizontal cross member 113 and being threadingly engaged with matching female threaded holes in a mounting flange disposed on the proximal end of ram actuating device 103. In this manner ram actuating device may be releasably attached to horizontal cross member 113 and thereby may be secured to first ram side structure 101 and second ram side structure 102 as well; however, it is to be understood that any means of attachment, releasable or unreleasable, may be utilized to secure both the distal and the proximal ends of ram actuating device 103 to the other components of the invention such that ram actuating device 103 is securely held in place and that operation of ram actuating device 103 operates to compress the earth mixture into compressed earth blocks, and that the particular attachment configuration depicted in the figures of the drawings is but one example of such attachment configurations.

Still referring to FIGS. 3 and 4a, ram head 104, which is preferably interchangeable in the invention so that ram heads of differing shapes or configuration may be utilized in the invention as desired by the user, may be releasably attached to the actuated element of ram actuating device 103 by any means known in the mechanical arts, but is preferably releasably attached by use of threaded fasteners, or by a clevis pin which may further be secured by a cotter pin. Hopper 110, which is utilized to direct the earth mix into fill chamber 120, may be disposed on upper surfaces of first ram side structure 101 and second ram side structure 102 and may be secured thereto by any means known in the mechanical arts such as threaded fasteners, rivets, welding, chemical bonding or any other means, but is preferably threaded fasteners. Hopper 110 is preferably located directly over fill chamber 120 so that earth mix is directed into fill chamber 120 by hopper 110.

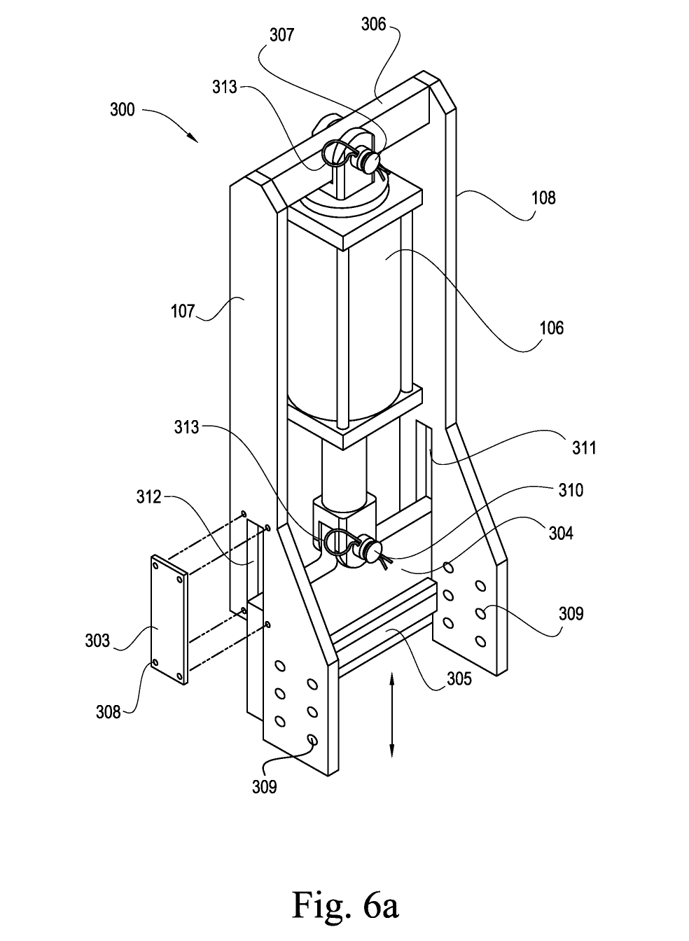

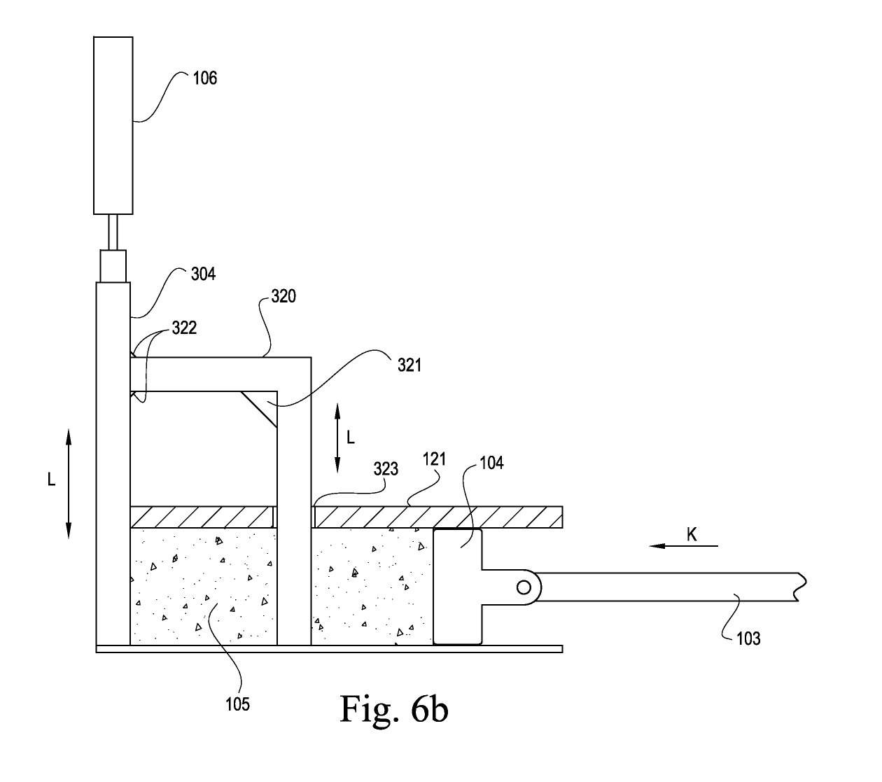

Still referring to FIGS. 3 and 4a, vertical headgate subassembly 127 may be disposed at the proximal end of ram apparatus 100. Vertical headgate subassembly 127 may operate to preferably releasably secure a headgate actuating device, such as for example a hydraulic cylinder, a pneumatic cylinder, or an electrically operated actuating device such as a solenoid, so as to translate headgate 304 so that it operates to close or open the proximal end of compression chamber 105. Vertical headgate subassembly 127 is further shown in FIGS. 6b and 6b and is also further described below. Vertical headgate subassembly 127 may comprise a right headgate cylinder support 107 and a left headgate cylinder support 108 which may be attached to first ram side structure 101 and second ram side structure 102, respectively, by any attachment means releasable or unreleasable, but which is preferably releasable and may be, as an example, threaded fasteners 117 as depicted in FIG. 3. When headgate 304 is in a closed position at the bottom end of its travel, it operates to close ram compression chamber 105 so that the earth mix may be compressed into a finished earth block when ram head 104 is motivated by operation of ram actuating device 103, moving the earth mix located in fill chamber 120 into compression chamber 105. Ram actuating device continues to apply force to ram head 104 in the direction of the proximal end of compression chamber 105, causing compression of the earth mix to a desired compression value and creating a compressed earth block. Once the desired compression value has been held for a desired amount of time, headgate cylinder 106 may operate to translate headgate 304 upward such that the proximal end of compression chamber 105 is opened, whereupon ram actuating device 103 may be extended to translate ram head 104 further in the proximal direction, pushing the compressed earth block out of compression chamber 105 and preferably onto exit shelf 202 (not shown in FIG. 3). Mounting hardware 116, which may be male threaded fasteners, may pass through matching clearance holes in first ram side structure 101 and second ram side structure 102 to be threadingly engaged with matching female threaded holes in compression chamber first side plate 122 and compression chamber second side plate 124 in order to attach compression chamber 105 to first ram side structure 101 and second ram side structure 102.

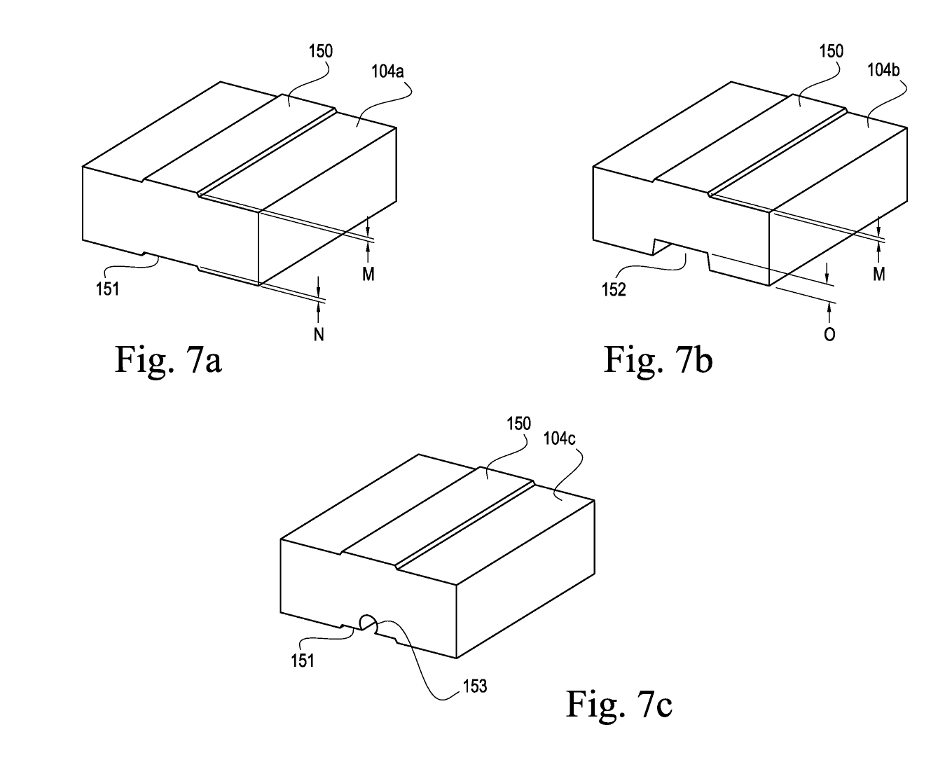

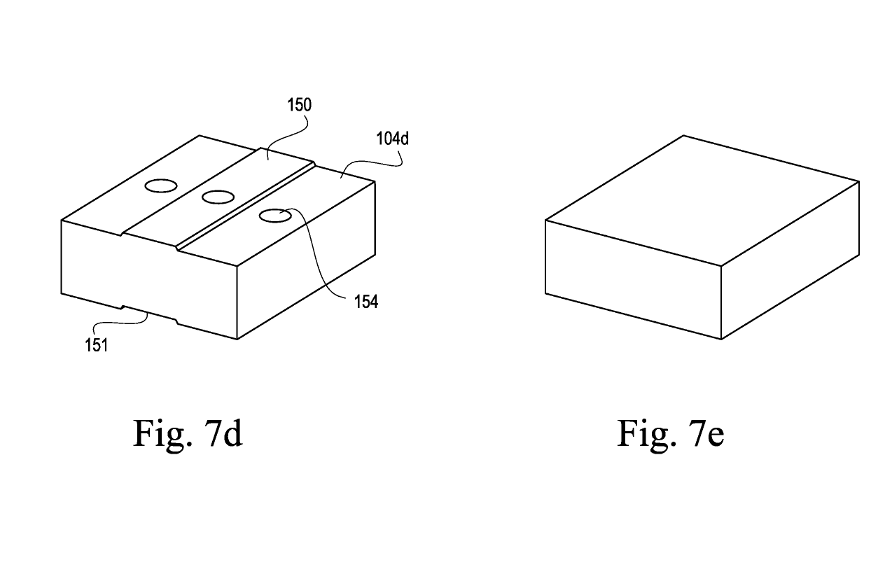

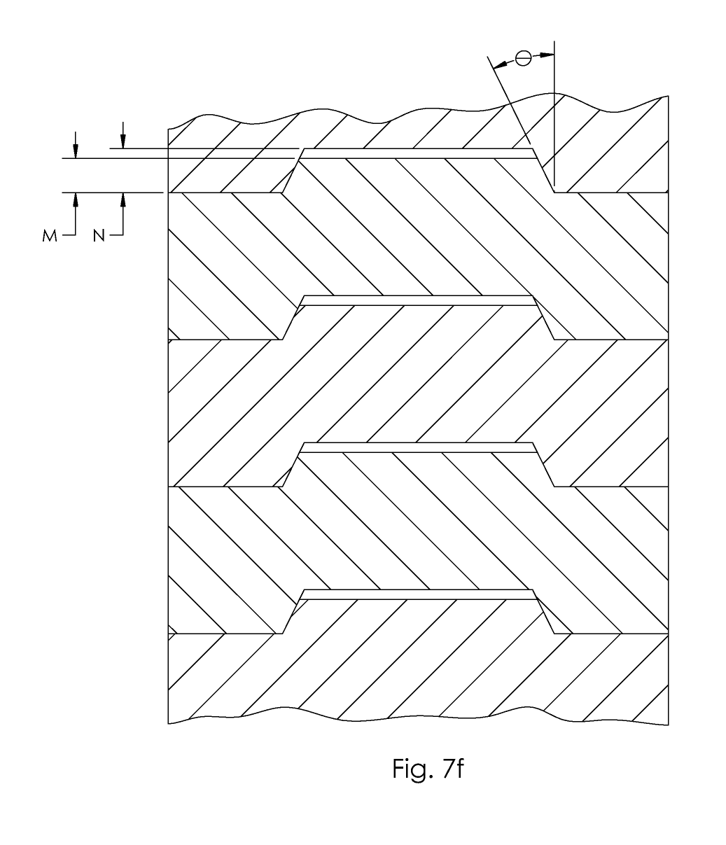

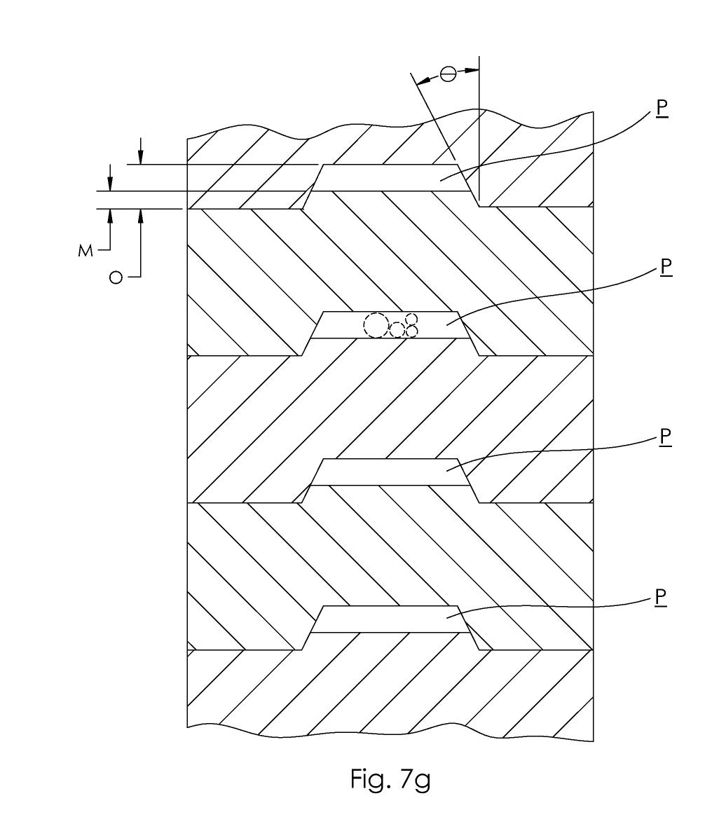

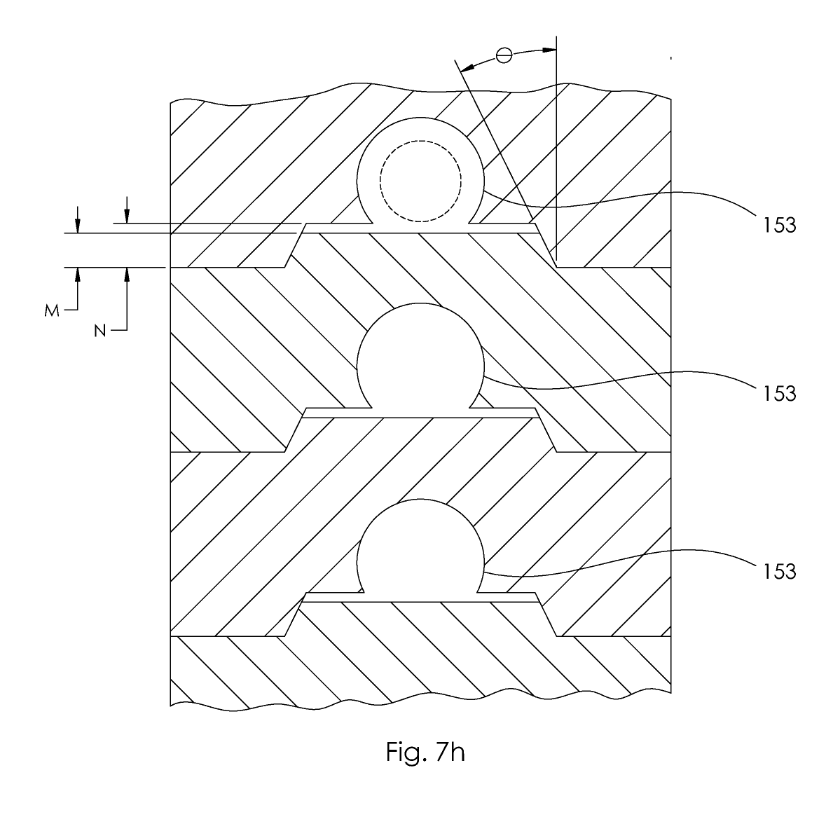

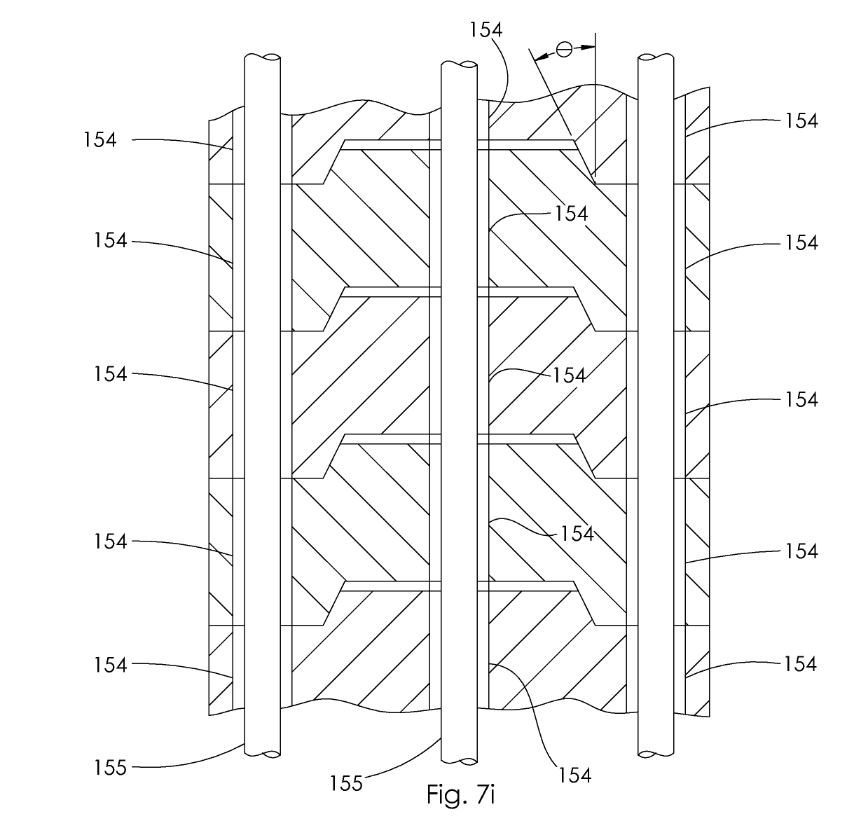

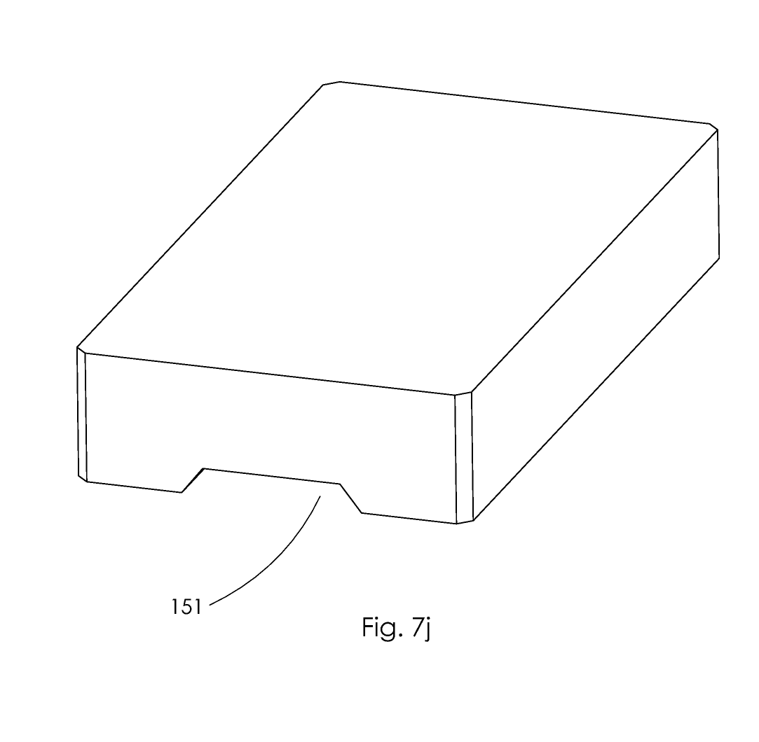

Referring now to FIG. 4b, a cross-sectional view of a ram compression chamber 105 of the invention is depicted. Ram compression chamber 105 is bounded on its top by compression chamber top plate 121, by its bottom on compression chamber bottom plate 123, on one side by compression chamber first side plate 122 and on another side by compression chamber second side plate 124. Each of compression chamber top plate 121, compression chamber first side plate 122, compression chamber bottom side plate 123 and compression chamber second side plate 124 may be independently cast, molded, machined or otherwise fabricated and may be attached to one another by use of threaded fasteners, welding, chemical bonding, or by any other attachment means known in the art to form a unitary unit. In a preferred embodiment and best mode, compression chamber top plate 121, compression chamber first side plate 122, compression chamber bottom side plate 123 and compression chamber second side plate 124 may be releasably attached by being bolted together using threaded fasteners or equivalent releasable mechanical fasteners or attachment means such that they may be disassembled to allow a user to interchange any of compression chamber top plate 121, compression chamber first side plate 122, compression chamber bottom side plate 123 or compression chamber second side plate 124, if it is desired to create compression earth blocks with particular features such as channels, tongues or grooves. This preferred embodiment interchangeability and releasable attachment of compression chamber top plate 121, compression chamber first side plate 122, compression chamber bottom side plate 123 and compression chamber second side plate 124 is a significant improvement over the prior art because it allows a single ram apparatus to produce virtually any cross section earth block desired. In the example shown in FIG. 4b, which is only one of a practically endless embodiments of ram compression chamber 105 cross sections that result in a similar practically endless embodiments of compressed earth block cross sections such as those examples shown in FIGS. 7a-7j, compression chamber first side plate 122, compression chamber bottom side plate 123 and compression chamber second side plate 124, a tongue and groove earth block similar to the block depicted in FIG. 7a may be formed by motivating earth mix into compression chamber 105 by operation of ram actuating device 103 (not shown in FIG. 4b), closing the proximal end of compression chamber 105 by motivating headgate 304 (not shown in FIG. 4b) into position to close the proximal end of compression chamber 105 by operation of headgate cylinder 106 (not shown in FIG. 4b), and by motivating ram head 104 (not shown in FIG. 4b) by further extension of ram actuating device 103 such that ram had 104 compresses the earth mix filling chamber 105. The compression created by pressing ram head 104 against the earth mix in compression chamber 105 causes the compressed earth block to form. Mounting hardware 116, which may be male threaded fasteners, may pass through matching clearance holes in first ram side structure 101 and second ram side structure 102 to be threadingly engaged with matching female threaded holes in compression chamber first side plate 122 and compression chamber second side plate 124 in order to attach compression chamber 105 to first ram side structure 101 and second ram side structure 102.

Still referring to FIG. 4b, a preferred embodiment of ram head 104 (not shown in FIG. 4b) is that it's periphery take a matching shape to the cross section of ram compression chamber 105, so that when ram head 104 is motivated proximally by extension of ram actuating device 103, ram head 104 slides into and is slidingly engaged on all its surfaces with the interior surfaces of ram compression chamber 105, forming a sliding distal wall in ram compression chamber 105.

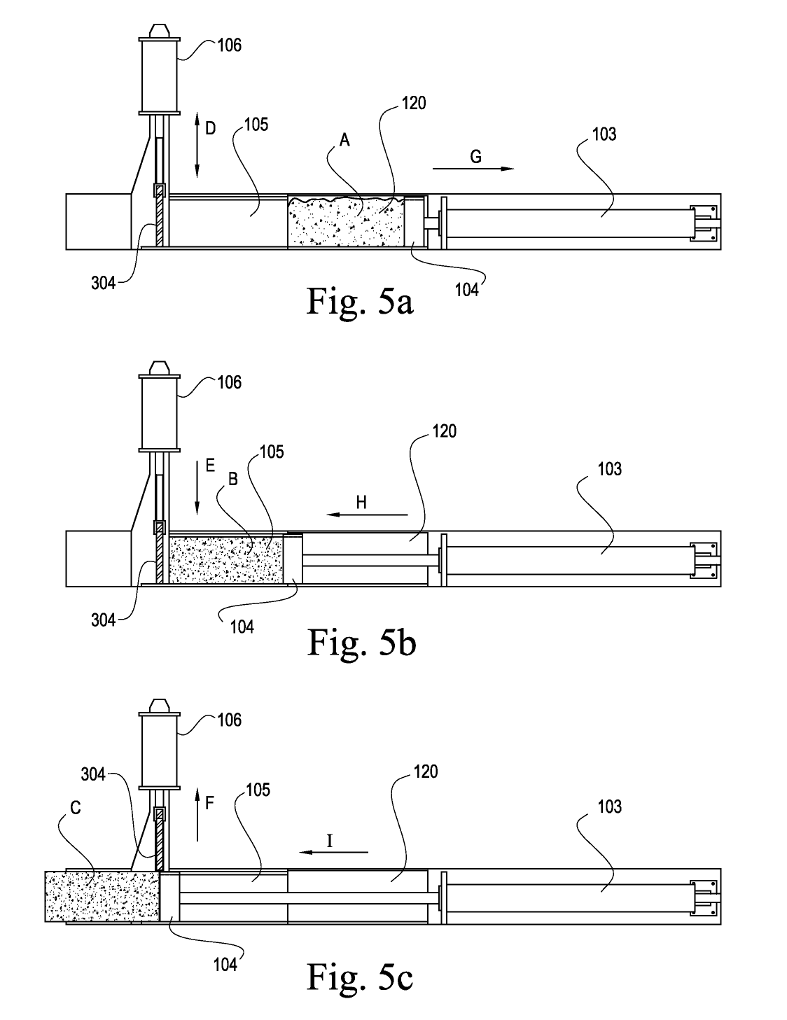

Referring now to FIG. 5a, a side cross-section view of a preferred embodiment of the ram apparatus of the invention during a fill stage of the earth block ram procedure in which the Earth cement mixture has been loaded into the fill chamber of the invention is depicted. The earth mix A has been loaded into fill chamber 120, preferably but not necessarily through hopper 110. Hopper 110 is not shown in FIG. 5a for clarity. Ram actuating device 103 is in a fully retracted position as depicted by arrow G in the figure such that ram head 104 is retracted, allowing earth mix to enter fill chamber 120. Compression chamber 105 may be empty. The disposition of headgate 304 may be, but is not necessarily, in a fully downward position as indicated in the figure. It is to be noted that operation of headgate cylinder 106 may motivate headgate 304 along an axis of travel that operates to close the proximal end of compression chamber 105. During the initial stage of the earth block ram procedure in which the earth mix has been loaded into the fill chamber of the invention head gate, 304 may be in any position.

Referring now to FIG. 5b, a side cross-section view of a preferred embodiment of the ram apparatus of the invention during a compression stage of the earth block ram procedure in which the earth mix is being compressed in the ramming chamber of the invention is depicted. Earth mix may be moved from fill chamber 120 and compressed into an earth block B in compression chamber 105 by operation of ram actuating device 103 applying pressure in a proximal direction as depicted by arrow H in the figure and causing ram head 104 to compress earth mix B into a desired block shape. During this stage of the earth block ram procedure in which the earth mix is being compressed in the ramming chamber of the invention, headgate 304 is disposed in a downward position by extension of headgate cylinder 106 in the direction of arrow E in the figure such that it forms a closed proximal end of fill chamber 105.

Referring now to FIG. 5c, a side cross-section view of a preferred embodiment of the ram apparatus of the invention during a final stage of the earth block ram procedure in which a compressed earth block has been formed by the ram procedure and has been moved to an earth block exit shelf 202 of the invention is depicted. The compressed earth block B may be motivated in the proximal direction by extension of ram actuating device 103 applying pressure in a proximal direction as depicted by arrow I in the figure. During this stage of the earth block formation process, headgate 304 is disposed in an upward position by retraction of headgate cylinder 106 in the direction of arrow F in the figure such that it opens the proximal end of fill chamber 105 and allows the compressed earth block C to exit compression chamber 105. Fill chamber 120 remains empty so that ram head 104 may next be retracted into the position shown in FIG. 5a, whereupon the earth block compression procedure may begin again.

Referring now to FIG. 6a a perspective view of one embodiment of the head gate apparatus of the invention, depicting the head gate sliding engagement in the head gate vertical supports is shown. Head gate cylinder 106 may be disposed, but is not necessarily disposed, in a vertical orientation such that retraction or extension of headgate cylinder 106 operates to respectively raise or lower headgate 304 into a desired position in accordance with the operation of the earth block ram procedure of the invention. Headgate 304 may be fabricated from any structural material suitable to withstand the compression values used in forming compressed earth blocks, but is preferably metal such as steel. In alternate embodiments other materials may be used to fabricate headgate 304 such as aluminum, other metals, or any structural material able to withstand the compression values set forth herein without structural deformation. Headgate 304 is constrained to translate in a direction determined by the orientation of first head gate translation slot 311 and second head gate transition slot 312. Headgate transition slot cover 303 may be utilized to further constrain headgate 304 such that it operates smoothly to translate within first headgate transition slot 311 and second headgate transition slot 312. Headgate transition slot cover 303 may be attached to right headgate cylinder support 107 and left headgate cylinder support 108 by any means known in the mechanical arts but is preferably releasably attached using threaded fasteners, and further preferably using male threaded fasteners protruding through clearance holes 308 in headgate translation slot cover 303 and being threadingly engaged with matching female threaded holes in right headgate cylinder support 107 and left headgate cylinders support 108. Right headgate cylinder support 107 and left headgate cylinder support 108 may be attached to first ram side structure 101 (not shown in FIG. 6a) and second ram side structure 102 (not shown in FIG. 6a) by any means known in the mechanical arts, whether such attachment means are releasable or unreleasable. Preferably, right headgate cylinder support 107 and left headgate cylinder support 108 are releasably attached to first ram side structure 101 and second ram side structure 102 using male threaded fasteners which may protrude through clearance holes 117 in first ram side structure 101 and second ram side structure 102 and being threadingly engaged with matching female threaded holes 309 in right headgate cylinder support 107 and left headgate cylinder support 108.

Still referring to FIG. 6a, headgate bar 305 may be utilized to form a channel transverse to the longitudinal axis of the ram apparatus in a compressed earth block formed in compression chamber 105. An exemplary headgate bar 305 is shown in the figure. It is to be understood that the cross section of headgate bar 305 may take any cross section desired by the user. Headgate bar 305 may be attached to headgate 304 by any means known in the mechanical arts such as welding, chemical bonding, or any other means, but in a preferred embodiment headgate bar 305 may be attached to headgate 304 by threaded male fasteners passing through clearance holes in headgate 304 and being threadingly engaged with matching female threaded holes in headgate bar 305.

Still referring to FIG. 6a, headgate structure cross member 306 may be attached to right headgate cylinder support 107 and left headgate cylinder support 108 by any means known in the art but is preferably releasably attached by threaded male fasteners passing through clearance holes in right headgate cylinder support 107 and left headgate cylinder support 108 and being threadingly engaged by matching female threaded holes in headgate structure cross member 306. Headgate cylinder 106 may be attached at its distal end to headgate structure cross member 306 by any means known in the mechanical arts but is preferably releasably attached by pin 307 passing through clearance holes in the distal end of headgate cylinder 106, and passing through a hole in headgate structure cross member 306. Pin 307 may be retained by any retaining means known in the mechanical arts but may preferably be retained in place by cotter pin 313. Headgate cylinder 106 may be attached at its proximal end to headgate 304 by any means known in the mechanical arts but is preferably releasably attached by second pin 310 passing through a clevis on the proximal end of headgate cylinder 106, and passing through a hole in headgate 304. Pin 310 may be retained by any retaining means known in the mechanical arts but may preferably be retained in place by cotter pin 313.

Referring now to FIG. 6b, a side view of an alternative embodiment of the head gate apparatus of the invention in which one or more mandrel(s) 320, which may take any cross sectional shape, are utilized to form through channels in the earth block being formed in the ram chamber. Any number of mandrels 320 may be attached to headgate 304 in such an manner as to travel with headgate 304 when it is motivated by headgate cylinder 106. Mandrels 320 may be attached to headgate 304 by any means but may preferably be welded to headgate 304 at mandrel weld points 322, and mandrels 320 may be strengthened gussets 321 which may be attached to mandrels 320 by welding, chemically bonding, use of mechanical fasteners or any other means of attachment known in the art. A preferred number of mandrels is three. At least one mandrel 320 may be disposed so as to travel through matching mandrel clearance hole(s) 323 in compression chamber top plate 130. The presence of mandrels 320 operate to leave holes in the finished compressed earth block by forming columns in compression chamber 105 when they are motivated into compression chamber by extension of headgate cylinder 106 when headgate 304 is motivated into position to close the proximal end of compression chamber 105. Earth mix is compressed in the chamber by pressure exerted by ram head 104 motivated in the proximal direction K by ram actuating device 103 as hereinbefore described. Once the desired pressure has been achieved in fill chamber 105 for the desired amount of time, headgate cylinder 106 may be retracted, causing headgate 304 to no longer close the proximal end of compression chamber 105 and also causing mandrels 320 to be fully retracted from compression chamber 105 so that the finished earth block may be motivated from compression chamber 105 by further extension of ram actuating device 103. The compression of earth mix in compression chamber 105 around mandrels 320 causes voids to be formed in the compressed earth block in the cross sectional shape of the mandrels. These voids may be in alignment when compressed earth blocks are stacked, forming channels in the stacked earth block structure which may be used for any purpose such as, for instance, running cabling, wiring, plumbing, or other infrastructure, or may be used to pass reinforcing bar, cement or other reinforcing materials within the earth block structure. An example of such earth blocks formed by using three mandrels is depicted in FIG. 7d in which reinforcing bar 155 is located within transverse channels formed by the presence of mandrels 320 in compression chamber 105 during the earth block compression step.

Referring now to FIGS. 7a-7e and 7j, various configurations of compressed earth blocks as may be produced by the compressed earth block ram apparatus are depicted. Also, referring to FIGS. 7f-7i, exemplary stacks of compressed earth blocks are depicted. It is to be noted that the variation of earth block shapes and dimensions that may be formed by the compressed earth block ram apparatus be are so numerous that virtually any shape block may be produced, and the configurations of compressed earth blocks and earth block stacks depicted in the figures are but examples of the many shapes of compressed earth blocks and features that may be formed by the invention.

Referring now to FIGS. 7a and 7f, an earth block 104a having an tongue 150 of height M and a groove 151 of depth N formed by corresponding features in compression chamber 105 is depicted. Groove depth N may be of larger dimension than tongue height M so as to prevent interference when two compressed earth blocks of this configuration are stacked together. Likewise, tongue 150 and groove 151 side walls may be angled at an angle θ so as to facilitate assembly of the compressed earth blocks. Such angling of the side walls may act to guide the blocks together into alignment when they are assembled, and may reduce assembly time and allow for the use of unskilled labor in the construction of structures using the compressed earth blocks of the invention.

Referring now to FIGS. 7b and 7g, an alternate embodiment of the compressed earth blocks 104b formed by corresponding features in compression chamber 105 (not shown in FIGS. 7b and 7g) are depicted in which a tongue 150 of depth M and a groove 152 of depth O are formed in the compressed earth blocks. Groove depth O may be of larger dimension than tongue height M so as to create an interstitial space P between the two blocks when two compressed earth blocks of this configuration are stacked together. Interstitial space P may be used, for example, to run cabling such as television, phone, Ethernet, power, fiber optic, or other infrastructure cabling within a wall formed by such compressed earth blocks as may be produced by the compressed earth block ram apparatus. Likewise, tongue 150 and groove 152 side walls may be angled at an angle θ so as to facilitate assembly of the compressed earth blocks. Such angling of the side walls may act to guide the blocks together into alignment when they are assembled, and may reduce assembly time and allow for the use of unskilled labor in the construction of structures using the compressed earth blocks of the invention.

Referring now to FIGS. 7c and 7h, an alternate embodiment of the compressed earth blocks 104c having an tongue 150 of height M and a groove 151 of depth N formed by corresponding features in compression chamber 105 formed by corresponding features in compression chamber 105 (not shown in FIGS. 7c and 7h) is depicted in which a longitudinal channel 153 is disposed in a longitudinal direction of the compressed earth block as depicted in the figure. Longitudinal channel 153 may be formed by a corresponding feature disposed in compression chamber 105. Longitudinal channels 153 may be used, for example, to run cabling such as television, phone, Ethernet, power, fiber optic, or other infrastructure cabling within a wall formed by such compressed earth blocks as may be produced by the compressed earth block ram apparatus. Tongue 150 and groove 152 side walls may be angled at an angle θ so as to facilitate assembly of the compressed earth blocks.

Referring now to FIGS. 7d and 7i, an alternate embodiment of the compressed earth blocks formed by corresponding features in compression chamber 105 having an tongue 150 and a groove 151 formed by corresponding features in compression chamber 105 is depicted in which one or more transverse channels 154 may be disposed in a transverse direction of the compressed earth block as depicted in the figure. Transverse channels 154 may be formed by operation of mandrels 320 (not shown in FIGS. 7d and 7i, but shown in FIG. 6b). Transverse channels 154 may be used, for example, to run cabling such as television, phone, Ethernet, power, fiber optic, or other infrastructure cabling within a wall formed by such compressed earth blocks as may be produced by the compressed earth block ram apparatus. Alternatively, transverse channels 154 may be used to allow reinforcing bar to be inserted into the wall for strengthening of the wall, and cement or mortar may also be used to fill transverse channels 154. Tongue 150 and groove 152 side walls may be angled at an angle θ so as to facilitate assembly of the compressed earth blocks.

Referring now to FIG. 7e, a basic compressed earth block such as may be produced by the invention is depicted.

Referring now to FIG. 7j, a corner block configuration is depicted that may either be formed by corresponding features of ram compression chamber 105 (not shown in FIG. 7j) or may be formed by producing a compressed earth block as shown in FIG. 7a and utilizing the earth block slicing apparatus 700 of the invention to slice off tongue 150 as is discussed further herein.

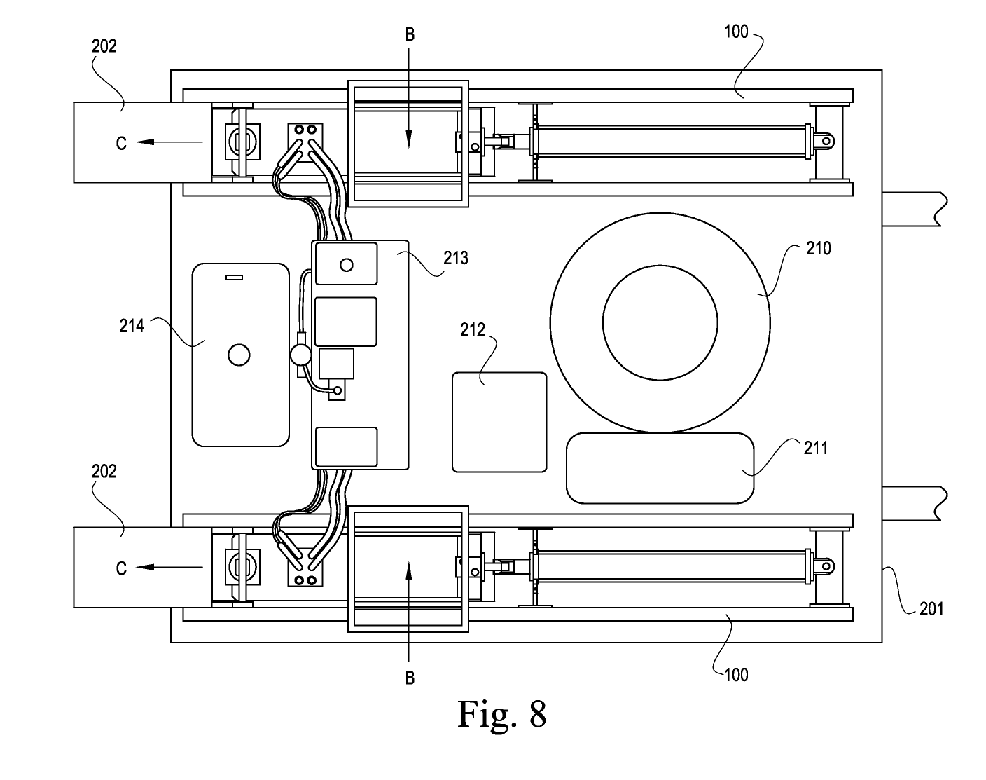

Referring now to FIG. 8, the invention may comprise a trailer 201; at least one but preferably two ram apparatuses 100 which may be disposed on either side of trailer 201; two compressed earth block exit shelves 202, each disposed in substantial alignment with a ram apparatus 100 such that earth block exit shelf 200 to receives a compressed earth block as it is motivated to exit the compression chamber by extension of ram actuating device 103; and a power source for powering ram actuating device 103 such as, for instance, a hydraulic pump 213 or air compressor. The trailerized mobile compressed earth block fabrication station of the invention may also comprise a cement mixer 210 and a cement mixer motor 211 for operating said cement mixer as is known in the art. Cement mixer 210 may be utilized to mix the earth mix as desired by the user. Additionally, the invention may comprise fuel storage in the form of fuel cans 212 which may be secured to the floor of trailer 201 by any means known in the art such as straps or the like. The trailerized mobile compressed earth block fabrication station of the invention may also comprise an electric generator 214 for providing power in remote locations.

Still referring to FIG. 8, it can readily be seen that earth mix may be loaded into ram apparatus 100 as depicted by arrow B in the figure whereupon the earth mix may be compressed in compression chamber 105 by operation of ram actuating device 103. Once the block has been compressed to a desired compression value for a desired period of time, headgate 304 may be translated such that it opens the proximal end of compression chamber 105 which allows the further extension of ram actuating device 103 to push the finished earth block onto Earth block exit shelf 202 where it may be picked up by a user and used to build a desired structure. Each ram apparatus 100 may be attached to the floor of trailer 201 by mounting hardware, which may be threaded fasteners, passing through the bottom flanges of first ram side structure 101 and second ram side structure 102. Likewise, power source 213 may be bolted to the floor of trailer 201. Cement mixer 210 and cement mixer motor 211, along with fuel storage container 212 may be bolted to the floor of trailer 201 or may be strapped to the floor of trailer 201 as desired by the user in order to facilitate ease-of-use.

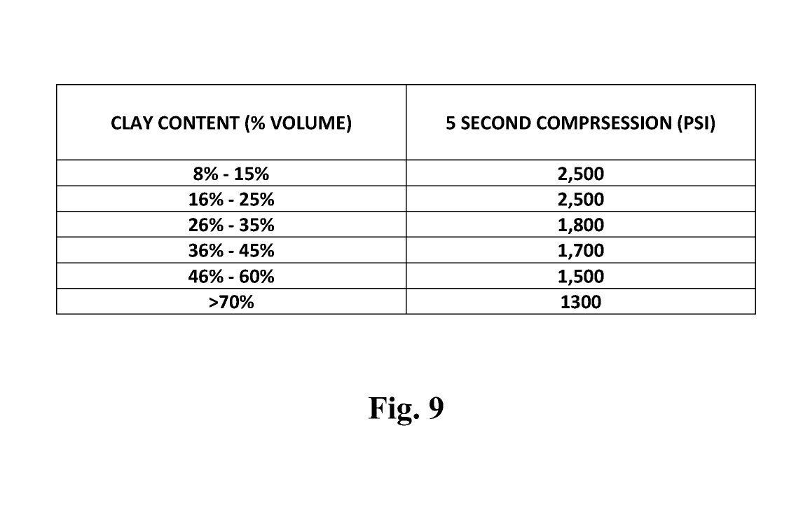

Referring now to FIG. 9, a compressed earth block may be formed by applying compressive forces as depicted in FIG. 9 for length of time also is depicted in FIG. 9 as may be desired by the user. A preferred range of five minute compression values are depicted which vary by the clay content of the earth mix. As shown in the table, an earth block formed from earth mix comprising a clay content of 8% should be compressed at a value of 2,500 lbs/sq. in. (P.S.I.) for a period of five minutes; earth blocks formed from clay content between 16% and 25% should be compressed at 2,500 P.S.I. for a period of five minutes; earth blocks formed from clay content between 26% and 35% should be compressed at 1,800 P.S.I. for a period of five minutes; earth blocks formed from clay content between 36% and 45% should be compressed at 1,700 P.S.I. for a period of five minutes; earth blocks formed from clay content between 56% and 60% should be compressed at 1,500 P.S.I. for a period of five minutes; and earth blocks formed from clay content over 70% should be compressed at 1,300 P.S.I. for a period of five minutes. In a preferred embodiment, a compression value of between 500 pounds per square inch for a period of five seconds is desired for an earth mix containing between 15 and 22% clay. The ranges and values shown in FIG. 9 are for various preferred embodiments of use of the invention: other times and compression values may be utilized to form earth blocks with the invention and such other values are within the scope of the appended claims.

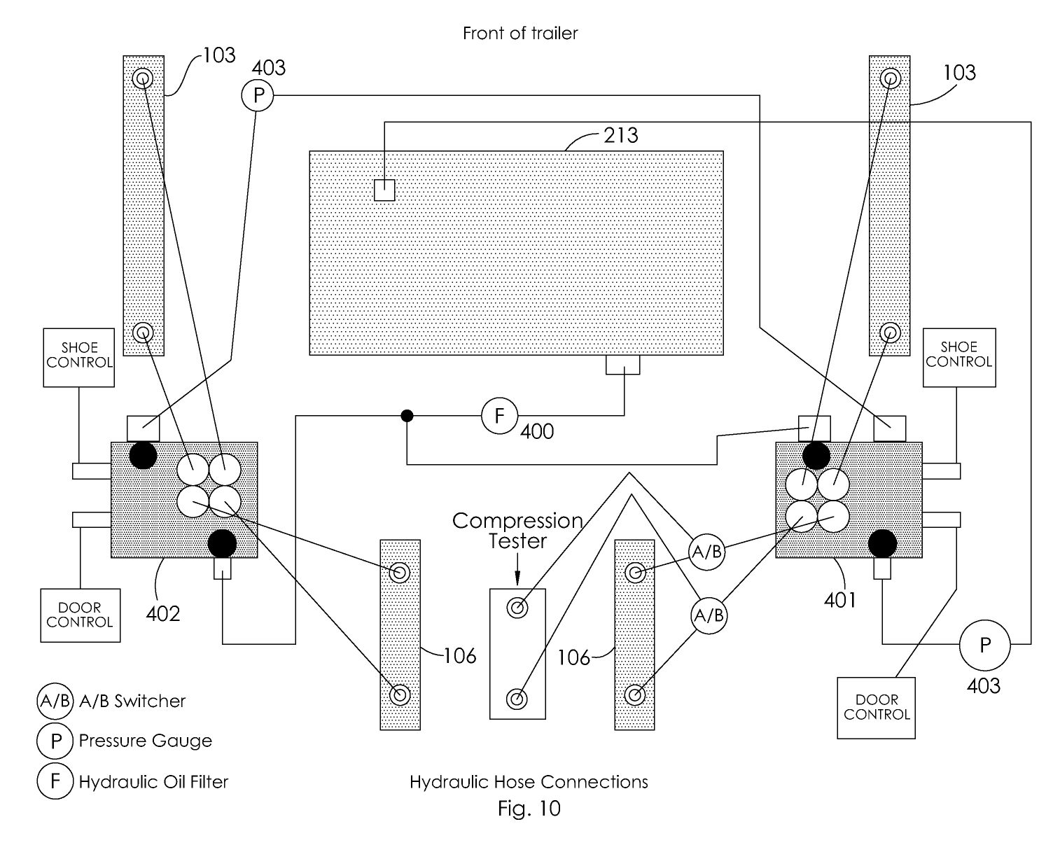

Referring now to FIG. 10, a schematic of the hydraulic configuration of the invention is depicted. The elements of the invention are in hydraulic fluid communication as depicted by the lines connect the elements. The particular embodiment of the invention depicted in FIG. 10 is for the embodiment comprising two compressed earth ram apparatuses 100 each comprising a ram actuating device 103 which, in the embodiment depicted, is a hydraulic cylinder. Furthermore headgate cylinder 106 is also a hydraulic cylinder in the particular embodiment of the invention depicted in the figure. Hydraulic pump 213 operates to supply pressurized hydraulic fluid at a desired pressure. Hydraulic pump 213 may be in hydraulic fluid communication with first hydraulic switch 401 and second hydraulic switch 402 through optional hydraulic filter 400. A preferred embodiment of the invention comprises optional hydraulic filter 400 but optional hydraulic filter 400 is not necessary in alternate embodiments of the invention. First hydraulic switch 401 is in hydraulic fluid communication with a first ram actuating device 103, and likewise second hydraulic switch 402 is in hydraulic fluid communication with a second ram actuating device 103. In the particular embodiment of the invention disclosed in FIG. 10 ram actuating devices 103 are double acting hydraulic cylinders. In alternate embodiments of the invention ram actuating devices 103 need not be double acting; and still further, and other alternate embodiments of the invention ram actuating devices 103 may be pneumatically operated single or double acting pneumatic cylinders. Pressure gauges 403 may be disposed as depicted in the figure. Operation of headgate control lever on first hydraulic switch 401 causes headgate cylinder 106 to extend or retract as commanded. Operation of ram control lever on first hydraulic such 401 causes ram actuating device 103 to extend or retract as commanded supplying pressurized hydraulic fluid to one the other end of ram actuating device 103. Likewise, operation of ram control lever on second hydraulic switch 402 causes ram actuating device 103 to extend or retract as commanded, and operation of headgate control lever on second hydraulic switch 402 causes headgate cylinder 106 to extend or retract as commanded. In this manner, for each of the two ram apparatuses in this exemplary dual ram configuration, the position of each headgate is controllable by operation of the headgate control levers, and the position in compressive force exerted by ram head 104 mounted to ram actuating device 103 is controllable by operation of the ram control levers.

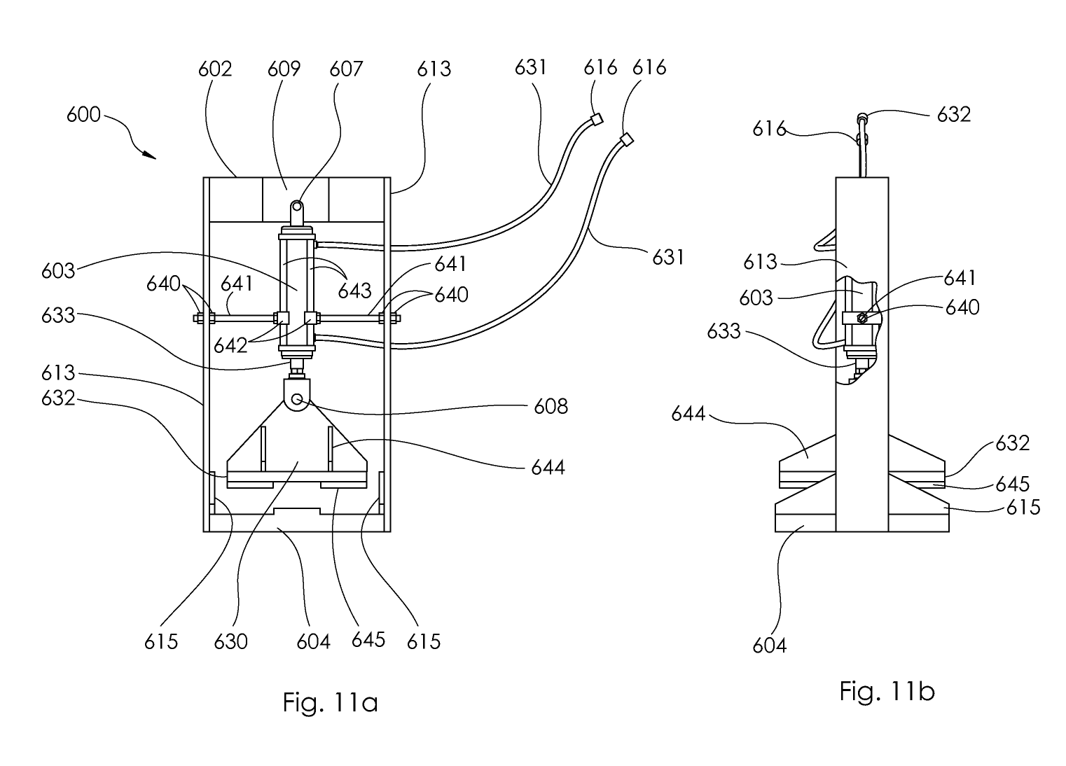

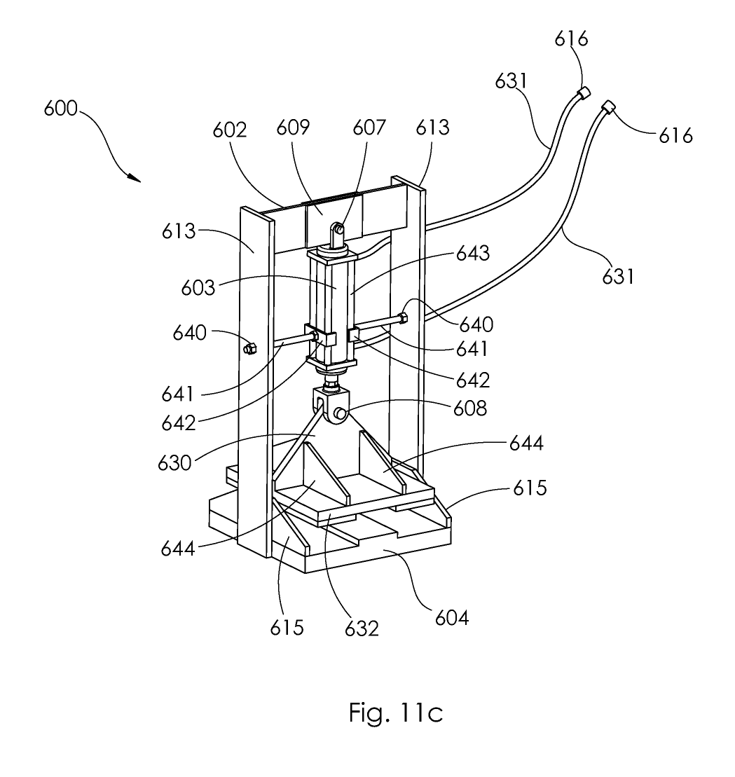

Referring now to FIGS. 11a, 11b and 11c, the compression testing device 600 of the invention is depicted. Compression testing device 600 may be utilized to compressively test earth blocks that have been fabricated by a ram apparatus of the system. Compression test frame may be comprised of a top plate 602, two side plates 613, and a compression test bottom plate 604, all of which may be independently fabricated from any metal, composite, wood or other structural material that is capable of withstanding the forces of compression testing, but are preferably fabricated from steel and attached as depicted using any attachment means known in the mechanical arts such as welding, chemical bonding, threaded fasteners or other means, but are preferably attached using threaded fasteners. As an example of an alternative embodiment, the compression test frame may also be fabricated from steel tubing of square or other cross section that is welded to form a rectangular frame. The compression test frame may be strengthened by gussets 615 which may be fabricated from any metal, composite, wood or other structural material, but are preferably fabricate from steel. Gussets 615 may be attached to side plates 613 by any means known in the art such as welding, threaded fasteners, chemical bonding, rivets, mechanical fasteners or any other attachment means known in the art, but preferably are attached by threaded fasteners. Compression test plate 604, which may be fabricated from any metal, composite, wood or other structural material that is capable of withstanding the forces of compression testing, but is preferably steel, may be attached to side plates 613 by any means known in the mechanical arts including but not limited to welding (in the case in which compression test frame components are weldable metal); chemical bonding; riveting or attachment using mechanical fasteners such as threaded fasteners. In alternate embodiments of the invention, top plate 602, the two side plates 613, and a bottom plate 604 may be formed of unitary structure such as by casing or molding. An earth block test article, which may be but is not necessarily an earth block produced by a ram apparatus of the invention, may be placed upon a top surface of compression test bottom plate 604 for compression testing. Compression test platen 632 may be motivated downward in the direction of arrow R by compression test cylinder 603 which may be a hydraulic cylinder, a pneumatic cylinder or an electric solenoid-operated cylinder. Compression test platen 635 may be attached to compression test cylinder piston 633 by pin 608 passing through a clearance hole in compression test cylinder piston 633 and also passing through a clearance hole in gusset 630 which may be attached to compression test platen 632 by any means known in the art such as for example welding, threaded fasteners, chemical bonding, rivets, mechanical fasteners or any other attachment means known in the art; but compression test platen 632 and gusset 630 are preferably fabricated from steel and are welded together. Pin 608 may be retained in place by a cotter pin or any other retention means known in the art. Compression test cylinder 603 may be attached at its upper end to compression test frame by pin 607 passing through a clearance hole in compression test cylinder 603 and also passing through a clearance hole in top plate 602 which may further comprise doubler plate or plates 609. Top plate 602 may be attached to side plates 613 by any means known in the art such as for example welding, threaded fasteners, chemical bonding, rivets, mechanical fasteners or any other attachment means known in the art; but top plate 602 and side plates 613 are preferably fabricated from steel and are welded together.

Still referring to FIGS. 11a, 11b and 11c, compression test cylinder 603 may be single-acting or double-acting, but preferably is double-acting. Fluid pressure hose 631, which may be hydraulic hose in the case in which compression test cylinder 603 is a hydraulic cylinder or may be pneumatic in the case in which compression test cylinder 603 is a pneumatic cylinder, may be in fluid communication with power source 213. Preferably, quick disconnect fittings 616 operate to efficiently and rapidly connect fluid pressure hose 631 to the appropriate pressure hose providing pressurized fluid from power source 213 to compression test cylinder 603. Compression test cylinder 603 may be powered from dedicated pressurized fluid ports on power source 213 or may be powered by disconnecting the fluid pressure hoses to one of the other cylinders of the invention, such as headgate cylinder 106 (not shown in FIGS. 11a, 11b or 11c but shown in FIG. 3) using quick-disconnect fittings and attaching those fluid pressure hoses to fluid pressure hoses 631, preferably by use of quick disconnect fittings 616. Such reconfiguration of the fluid pressure hoses to one of the other cylinders of the invention may be temporary for the testing a few or many earth blocks, after which time the fluid pressure hoses may be re-attached to be in fluid communication with the cylinder from which they were detached, returning that cylinder to normal operation. The use of quick disconnect fittings reduces the time required to configure a compression test of a compressed earth block. Lateral supports 641, which may comprise metal rods or similar structure, may be attached to side plates 613 and to sliding lateral support connectors 642 which may be slidingly engaged with cylinder support rods 643. Female threaded nuts 640 may be threadingly engage with matching male threads on lateral supports 641, attaching lateral supports 641 side plates 613.

Still referring to FIGS. 11a, 11b and 11c, earth block test articles may be compression tested by placing the earth block to be tested between compression test platen 632 and compression test bottom plate 604, and then activating compression test cylinder 603 so as to extend compression test cylinder piston 633 downward in the direction of arrow R, which applies pressure on the earth block test article. The pressure applied to the earth block test article may be any pressure desired by the user, and may be set by adjusting the pressure control of power source 213. Once the earth block test article has been subjected to compression testing as described above, it may be visually observed for any cracks or other deformities that are visible to the naked eye. If cracks are visible in any external surface of the earth block test article, the earth block mixture may need to be adjusted by reducing the amount of clay in the earth mix or by changing other ratios of the earth mix. Optional adapter plates 645 may be utilized to conform to the surface of a specific earth block test article, if desired. In a preferred embodiment, compression testing may be accomplished using the compression testing device 600 of the invention operating at or about 300 P.S.I. pressure into compression test cylinder 603, which, in the best mode of the invention, may be either a 3 inch or 4 inch diameter double-acting hydraulic cylinder. While these pressure and diameter values are provided herein for purposes of disclosing a preferred embodiment and best mode of the invention, it is to be understood that other cylinder diameters, pressures, and cylinder types may be utilized in the invention. Additionally, it is preferred, but not necessary, that earth blocks be tested at twenty-eight days after being produced. Thus, a preferred compression test method may comprise the steps of:
a. producing a compressed earth block;
b. waiting twenty-eight (28) days;
c. placing said compressed earth block between compression test platen 632 and compression test bottom plate 604 of the compression testing device 600 of the invention;
d. applying compression to said earth block by motivating said platen onto said earth block and applying pressure onto said platen by a cylinder, which is preferably a hydraulic cylinder of 3 or 4 inch diameter with inlet hydraulic fluid pressure of 300 P.S.I.; and
e. observing the exterior surfaces of said compressed earth for visible cracks or surface deformities.

Referring now to FIGS. 12a and 12b, an earth block slicing apparatus 700 of the invention is depicted. The invention may comprise an earth block slicing station that may be utilized to slice compressed earth blocks in their pre-cured state in the following manner. As ram actuating device 103 motivates ram head 104 along the longitudinal axis T of a random apparatus 100 of the invention, a compressed earth block is motivated to exit compression chamber 130 by the operation of ram head 104 translating in the direction of arrow T. The compressed earth blocks exiting compression chamber 103 rests upon the upper surface 712 of exit shelf 202, and as multiple compressed earth blocks 714 and 715 exit compression chamber 103 they stack along a longitudinal axis T. In some cases it may be desired to trim, or slice, a compressed earth block along a plane that is vertically oriented and that is also oriented at a 45° angle from longitudinal axis T. Such sliced blocks may be useful, for instance, for forming corners when compressed earth blocks are stacked to form a structure. First slot 703 and fourth slot 706 may be aligned and oriented at a 45° angle to longitudinal axis T. Likewise, second slot 704 and third slot 705 may be aligned and also oriented at a 45° angle to longitudinal axis T. Since the compressed earth blocks exiting compression chamber 103 have not been cured, they may be sliced by operation of a slicing wire which may be formed from any wire material, including but not limited to piano wire, depicted as item 713 and wherein wire loops 701 have been formed by looping the wire back on itself in creating wire twist 702. Wire loops 701 therefore provide a convenient handle such that slicing wire 713 may be motivated back and forth, slicing the compressed earth block. It can be seen from FIG. 12a that slicing wire 713 may be placed within opposing slots and utilized to slice a compressed earth block. When slicing wire 713 is disposed within opposing slots 703 and 706 it may be used to completely slice through an earth block forming a 45° end face on said earth block. Likewise, when slicing wire 713 is displaced within opposing slots 704 and 705 it may be used to completely slice through an earth block forming a 45° end face on said earth block. While a 45° angle is discussed herein, it is to be understood that opposing slots 703 and 706 and opposing slots 704 and 705 may be oriented at any desired angle to longitudinal axis T.

Still referring to FIGS. 12a and 12b, slicing station first wall 709 and slicing station second wall 710 may be attached to a side surface of exit shelf 202 using mounting hardware 711 located at at least one, but preferably a plurality, of locations. Mounting hardware 711 may take the form of male threaded fasteners secured with matching female nuts, rivets, or any other form of mechanical fastener known in the mechanical arts. Likewise, slicing station first wall 709 and slicing station second wall 710 may be fabricated of unitary construction with exit shelf 200 to by any process known in the art such as, for instance, casting or molding. Exit shelf 202, slicing station first wall 709 and slicing station second wall 710 may be fabricated from any structural material known in the art of sufficient strength to support a plurality of compressed earth blocks as they are motivated from compression chamber 130 by operation of ram actuating device 103. Exit shelf 202, slicing station first wall 709 and slicing station second wall 710 are preferably fabricated from metal but may be fabricated from plastic, fiberglass, wood, phenolic or any other structural material.

Still referring to FIGS. 12a and 12b, the earth block slicing apparatus 700 of the invention may be utilized to slice the tongue from an earth block as shown. Slicing wire 713 may be motivated back and forth in the direction of double arrow S by grasping loops 701 and motivating slicing wire by hand or by automated means. Slicing wire is disposed so as to slice tongue 150 from earth block 714. Removed tongue area 716 is a planar area that is depicted by cross hatching in the figure, and may be coplanar with the top of block 714 as is shown in more detail in FIG. 12c.

Referring now to FIG. 12c, slicing wire 713 may be motivated back and forth by hand or by other means in the direction of double arrow S in order to slice tongue 150 from compressed earth blocks 714 as compressed earth blocks 714 are motivated along the longitudinal axis of the ram apparatus. Slicing wire 713 may be placed within fifth slot 707 and six slot 708, each of which have a bottom surface that is disposed to be coplanar with the top surface of compressed earth blocks 714. Thus, when slicing wire 713 displaced within fifth slot 707 and sixth slot 708 such that it bottoms out against the bottom surface of each lot, wire 713 may skim the upper surface of compressed earth blocks 714 and completely slice, or remove, tongue 150 from earth block 714. Also depicted in FIG. 12c are exit shelf 202 and slicing station wall mounting hardware 711, which may be utilized to attach slicing station first wall 709 and slicing station second wall 710 to exit shelf 202. It can thus be seen that slicing station 700 may be operated by hand without the need for additional power, such as electric power which may be beneficial when the invention is used in remote locations where electric power may not be available.

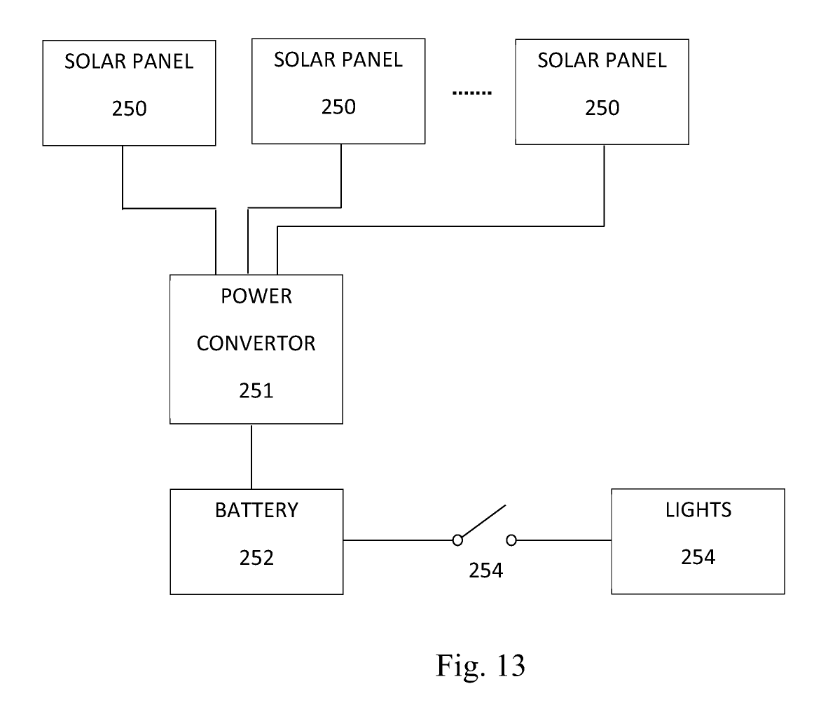

Referring now to FIG. 13, a block diagram of the solar powered lighting of the invention is depicted. One or more solar panels 250 (not shown in FIG. 13) may be mounted on any of the exterior surfaces of the invention as shown in FIG. 2a, 2b or 2c. The solar panels of the invention may be in electrical communication with a power convertor 251 which may operate to convert the raw output from solar panels 250 to a voltage that is appropriate for charging a battery 252. Battery 252, which may be one or a plurality of batteries, may be in electrical communication with lights 254 which may be an LED, incandescent, or any other type of lighting that will operate from a DC source such as a battery. Optionally, an electrical inverter may be in electrical communication with battery 252 for providing AC power to auxiliary apparatuses that may be present. An electrical switch 253 may be electrically interposed between battery 252 and lights 254 in order to command lights 254 into an ON or OFF state. Any number of switches 253 may be utilized, allowing several groups of lights to be independently switched in to an ON or OFF state depending upon the desires of the user. Lights 254 may comprise one or a plurality of lights that may be attached to any surface of the invention, but preferably are attached to the underneath side of any of covers 201a, 201b, 201c, 201d, or 201e.

The steps of producing and, in a preferred embodiment, compression testing an earth block using the apparatus of the invention, may be described as follows:
a. Providing an earth mix for use in producing earth blocks;
b. Providing a means for compressing the earth mix into a desired shape to form an earth block;
c. Compressing the earth mix into the desired shape to a pre-determined compression value thereby forming a compressed earth block;
d. Motivating the compressed earth block from the compression apparatus;
e. Applying compressive forces to the compressed earth block to test its strength;
f. Observing whether the compressed earth block exhibits cracking;
g. Determining whether the earth mix and compression values used in earth block formation are adequate based on the observation made in step f: if no structural failure of the compressed earth block is exhibited, declaring that the compression values used in earth block formation are adequate; and if structural failure of the compressed earth block is exhibited, declaring that the compression values used in earth block formation are not adequate;
h. If the compression values used in earth block formation are adequate, continuing production of earth blocks using the compression value; if the compression values used in earth block formation are not adequate, either change the earth mix formula by reducing the amount of clay in the mix, or increase the compression values used in earth block formation, or both, and repeat steps a through h as required to achieve an earth mix and compression values for earth block formation that are adequate.

Although a detailed description as provided in the attachments contains many specifics for the purposes of illustration, anyone of ordinary skill in the art will appreciate that many variations and alterations to the following details are within the scope of the invention. Accordingly, the following preferred embodiments of the invention are set forth without any loss of generality to, and without imposing limitations upon, the claimed invention. Thus the scope of the invention should be determined by the appended claims and their legal equivalents, and not merely by the preferred examples or embodiments given.

What is claimed is:

1. A mobile earth block ram system, comprising:
a trailer;
at least one earth block ram apparatus comprising a ram actuating device capable of extension and retraction upon command, a ram head connected to a proximal end of said ram actuating device, a fill chamber, and a ram compression chamber, and an energy source for providing energy to said at least one earth block ram apparatus to cause extension or retraction of said ram actuating device:
wherein said ram head motivates said earth mix from said fill chamber into said ram compression chamber, whereupon said ram head is further motivated by said ram actuating device to cause a pre-determined pressure on said earth mix in said ram compression chamber, forming a compressed earth block.

2. The mobile earth block ram system of claim 1, wherein said earth block ram apparatus further comprises, a head gate and an earth block exit shelf for receiving compressed earth blocks.

3. The mobile earth block fabrication system of claim 1, wherein said at least one earth block ram apparatus further comprises an interchangeable compression chamber having a top plate and a bottom plate.

4. The mobile earth block fabrication system of claim 1, wherein said headgate further comprises at least one mandrel, wherein said mandrel passes through a matching opening in said top plate of said compression chamber and extends through said compression chamber to contact a top surface of said bottom plate of said compression chamber.

5. The mobile earth block fabrication system of claim 1, further comprising a compression testing apparatus.

6. The mobile earth block fabrication system of claim 1, further comprising a block slicing station.

7. A method for producing compressed earth blocks, comprising the steps of:
a. Providing an earth mix for use in producing earth blocks;
b. Providing a means for compressing the earth mix into a desired shape to form an earth block;
c. Compressing the earth mix into the desired shape to a pre-determined compression value thereby forming a compressed earth block; and
d. Motivating the compressed earth from the compression apparatus.

8. The method of claim 7, further comprising the steps of:
e. Applying compressive forces to the compressed earth block to test its strength;
f. Observing whether the compressed earth block exhibits any sign of structural failure;
g. Determining whether the earth mix and compression values used in earth block formation are adequate based on the observation made in step f: if no structural failure of the compressed earth block is exhibited, declaring that the compression values used in earth block formation are adequate; and if structural failure of the compressed earth block is exhibited, declaring that the compression values used in earth block formation are not adequate; and
h. If the compression values used in earth block formation are adequate, continued production of earth blocks using the compression value; and if the compression values used in earth block formation are not adequate, either change the earth mix formula or increase the compression values used in earth block formation, or both, and repeat steps a through h as required to achieve an earth mix and compression values for earth block formation that are adequate.
